(19) United States
(12) Patent Application Publication
(10) Pub. No.: US 2022/0217996 A1
(43) Pub. Date: Jul. 14, 2022

(54) HIGH MOISTURE EXTRUDATES (HMEs) AND MEAT ANALOGUES

(71) Applicant: RIPPLE FOODS, PBC, Berkeley, CA (US)

(72) Inventors: Celia Homyak, Oakland, CA (US); John Frelka, Livermore, CA (US)

(73) Assignee: RIPPLE FOODS, PBC, Berkeley, CA (US)

(21) Appl. No.: 17/574,346

(22) Filed: Jan. 12, 2022

Related U.S. Application Data
(60) Provisional application No. 63/136,710, filed on Jan. 13, 2021.

(51) Int. Cl. A23J 3/22; A23J 3/14; A23J 1/14; A23J 3/26

(52) U.S. Cl. CPC A23J 3/227; A23J 3/14; A23L 13/426; A23J 3/26; A23J 1/14

(57) ABSTRACT

Disclosed are high moisture extrudates (HMEs) and high moisture meat analogues (HMMAs), generally made from the HMEs, containing acidic protein from plants precipitated at acidic pH. In some examples, the protein is from pea. In some examples, HMEs are disclosed that contain 100 percent of the plant salt-precipitated protein (before extrusion; after extrusion, product contains water). Also disclosed are meat analogues that contain the HMEs. In some examples, the meat analogues contain the HMEs along with additional plant protein that is not an ingredient of an HME.

### CROSS-REFERENCE TO RELATED APPLICATIONS

This application claims the benefit of priority to U.S. Provisional Application No. 63/136,710, filed on Jan. 13, 2021, the contents of which are incorporated herein.

### BACKGROUND

Food products that have the appearance, aroma, texture and taste of meat, but are non-meat may be called meat analogues or meat substitutes. Meat analogues do not contain substances from meat and may be referred to as vegetarian. Meat analogues may not contain any substances from animals and may be referred to as vegan. Meat analogues may contain protein sourced from plants. However, some plant-sourced proteins, such as soybean, may cause allergies in certain populations. Additionally, a continuing challenge faced by meat analogue developers is to produce a product that has the appearance, aroma, taste and texture of real meat. There is a growing need for meat analogues containing non-allergenic or hypoallergenic plant-sourced protein that realistically mimics the properties of meat.

### SUMMARY

Meat analogues, including high moisture meat analogues (HMMA), including vegan meat analogues containing a high moisture extrudate (HME) and meat hybrids that contain an HME have been developed. In some examples, the HMEs are made with salt-precipitated, non-meat or plant protein non-dairy protein. In some examples, the non-meat or plant protein has been salt-precipitated at an acidic pH. In some examples, the HMEs are made with non-salt-precipitated protein that has been precipitated at an acidic pH. These proteins, whether salt-precipitated or non-salt-precipitated, have an acidic pH. The protein preparations used to make the HMEs may be protein isolates or may be a refined protein preparation. In some examples, the refined protein preparation may have a protein content of at least 80% by weight. In some examples, the non-dairy proteins are non-allergenic or hypoallergenic. The proteins may be sourced from legumes. In some examples, the proteins are from peas. In some examples, the proteins used to make the meat analogues may have an aqueous solubility of less than about 15% (w/w). In some examples, the proteins may have a solution pH of less than about 7.1, 6.5, 6.0, 5.5, 5.0, 4.5, 4.0, 3.5, 3.0, 2.5 or less. In some examples, the proteins may have a pH in the range of about 3-7. In some examples, the proteins may have a sodium content of less than about 4500 ppm. In some examples, the HMMAs are made from HMEs that may be made 100% from a refined protein isolate that contains at least 80 percent by weight protein. In some examples, the vegan meat analogues contain an HME, as well as additional non-meat or plant protein that is not an ingredient of an HME.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

The following U.S. patents and U.S. published patent applications are each incorporated by reference in their entirety into this application:

U.S. Patent Publication No. 2019/0000112 A1 (Ser. No. 16/068,567), published Jan. 3, 2019 and titled, “Product Analogs or Components of Such Analogs and Processes for Making Same.”

Other references incorporated by reference may be listed throughout the application.

### BRIEF DESCRIPTION OF THE DRAWINGS

In the accompanying drawings, which are incorporated in and constitute a part of the specification, embodiments of the disclosed inventions are illustrated. It will be appreciated that the embodiments illustrated in the drawings are shown for purposes of illustration and not for limitation. It will be appreciated that changes, modifications and deviations from the embodiments illustrated in the drawings may be made without departing from the spirit and scope of the invention, as disclosed below.

FIGS. 1A, 1B and 1C illustrate example high moisture extrudates (HMEs) produced using the protein preparations described herein that were not salt-precipitated (FIGS. 1A and 1C) or a competitor plant protein that was not salt-precipitated (FIG. 1B).

FIGS. 2A, 2B and 2C illustrate example high moisture extrudates (HMEs) produced using the protein preparations described herein that were not salt-precipitated (FIG. 2A) or competitor plant proteins (FIGS. 2B and 2C).

FIGS. 3A, 3B and 3C illustrate processing of high moisture extrudates (HMEs) using the protein preparations described herein that were not salt-precipitated (FIG. 3A) or competitor plant proteins (FIGS. 3B and 3C).

### DETAILED DESCRIPTION

### Definitions

Unless defined otherwise, all technical and scientific terms used herein have the same meaning as commonly understood by one of ordinary skill in the art to which the present invention pertains. It is to be understood that the terminology used herein is for describing particular embodiments only and is not intended to be limiting. For purposes of interpreting this disclosure, the following description of terms will apply and, where appropriate, a term used in the singular form will also include the plural form and vice versa.

Herein, “adhesiveness” refers to the amount of work necessary to overcome attractive forces of a food to another contact surface. This property may be experienced as gooeyness, stickiness, tackiness, and the like.

Herein, “aftertaste” refers to a persistent, sometimes unpleasant sensation (e.g., taste) after a substance has been removed from the mouth. In some instances, the taste may be experienced near the end, at the end, or after the end of the chewing or swallowing process of a food or beverage.

Herein, “allergenic” means having the capability to induce allergy. “Non-allergenic” means not capable of causing allergy. “Hypoallergenic” means having a reduced ability to induce allergy. Generally, allergens are allergenic. In some examples, allergens refer to 8 significant food allergens recognized in the United States, including milk (including whey protein and/or caseinate), eggs, fish, crustacean shellfish, tree nuts, peanuts, wheat and soybeans.

Herein, “aqueous solubility” refers to the maximum amount of a substance (e.g., refined protein preparation) that can be dissolved in water at a given temperature.

Herein, “beef” refers to flesh of a cow, bull, ox and the like, used as a food. Herein, “veal” may be a type of beef.

Herein, “binder” refers to a substance or substances capable of holding a food together. Generally, the binder may hold edible particles (e.g., refined protein preparations) together.

Herein, “carbohydrate” includes sugar, starch, oligosaccharides, and cellulose. Herein, carbohydrates are generally from non-animal sources.

Herein, “cellulose” refers to D-glucose units joined by (1→4)-glycosidic bonds.

Herein, “chewiness” as used herein refers to the energy required to chew solid food until it can be swallowed. Chewiness may be determined using texture profile analysis (TPA) testing.

Herein, “chicken” refers to the bird and/or flesh from the bird, used as a food.

Herein, “chevon” refers to flesh from a mature goat, used as a food. Herein, flesh from a young goat, used as food, may be referred to as “kid.”

Herein, “cohesiveness” as used herein refers to a measure of the strength of internal bonds making up the body of the product and tendency of product to remain together, and resist breaking into several pieces, during compression. In some examples, this is the extent to which a food deforms when compressed. Generally, cohesiveness is determined using texture profile analysis (TPA) testing.

Herein, “coloring agent” generally refers to a substance that imparts a color to another substance. Herein, coloring agents may be used to impart a desirable color to a food.

Herein, “compress” means to make something smaller. One type of food compression uses a vacuum to remove or decrease the amount of air in a food.

Herein, “dairy” refers to food containing or produced from the milk of mammals.

Herein, “density” refers to mass per unit volume. Generally, density references the degree of compactness of a substance (e.g., a food).

Herein, “edible” means fit to be eaten.

Herein, an “egg” is laid by a female bird, reptile, fish or invertebrate. Herein, egg may refer to a chicken egg.

Herein, “emulsifier” refers to substances that stabilize emulsions.

Herein, “extrusion” refers to a process to create objects of a fixed cross-sectional area, where materials are forced through a die.

Herein, “fat” generally refers to lipids. Herein, fat includes both fats and oils. Herein, fats generally refer to non-animal fats.

Herein, “fish” refers to limbless cold-blooded vertebrate animals with gills and fins, wholly living in water.

Herein, “flavoring agent” refers to a substance that imparts flavor to another substance. Herein, flavoring agents may be used to make product a more natural taste.

Herein, “flour” refers to a powder obtained by grinding grain (e.g., wheat) and used to make foods. Flour may be a fine powder.

Herein, “food” refers to something edible.

Herein, “fracturability” refers to the force at first peak, using texture profile analysis (TPA) testing.

Herein, “gluten” refers to a group of proteins (e.g., gliadin and glutenin) present in cereal grains (e.g., wheat) that, when in a dough, contribute to its elastic texture.

Herein, “hardness” refers to maximum force achieved at the first bite or first compression, using texture profile analysis (TPA) testing.

Herein, “high moisture extrusion cooking” or “HMEC” refers to a wet extrusion process that often uses a twin screw extruder device. Herein, HMEC is used to describe a process in which non-dairy or vegan protein (e.g., plant protein) is used to produce high moisture extrudates (HMEs).

Herein, “high moisture extrudate” or “HME” refers to a product of the high moisture cooking (HMEC) process.

Herein, “high moisture meat analogue” or “HMMA” generally refers to a meat analogue or meat hybrid that contains a high moisture extrudate (HME). The HMMA, in addition to containing an HME, may also contain other ingredients.

Herein, “isolated protein” or “protein isolate” refers to a protein or population of proteins that are substantially isolated from a source. That is, non-protein components have been substantially removed or at least reduced in a preparation of isolated proteins. In some examples, components that may be removed may include insoluble polysaccharide, soluble carbohydrate, ash, other minor constituents and other components. Generally, herein, isolated protein refers to a population of proteins from one or more plant sources. Isolated protein may be in variety of forms, including for example, protein isolate, protein concentrate, protein flour, meal and/or combinations thereof. Generally, isolated proteins may not be refined proteins. Normally, isolated proteins may be subjected to one or more processing steps to obtain refined protein.

Herein, “meat” or “real meat” refers to the flesh of an animal.

Herein, “meat analogue” refers to meat-like substances that typically have an appearance, flavor and/or texture of real meat, but are not flesh of an animal. Herein, meat analogues generally contain non-dairy protein. The non-dairy protein may be from one or more plant sources. Herein, meat analogues are vegetarian and, herein, generally are non-dairy. Herein, meat analogues may be vegan. Herein, HMMA is a meat analogue. Herein, meat analogues may be made from HMEs. HMEs may be considered a meat analogue. Generally, “meat substitute” is a term equivalent to meat analogue.

Herein, “meat hybrid” or “hybrid meat” refers to a combination of a meat analogue and real meat. Generally, the meat hybrids disclosed herein contain an HMMA that has salt-precipitated protein. The meat analogues disclosed herein may also contain non-HMMA protein, which may be salt-precipitated protein. The meat hybrids disclosed herein also contain real meat. Any type of real meat may be used. Example non-limiting real meats that may be used include beef, chicken, lamb, mutton, pork, turkey, venison, and others.

Herein, “milk” refers to milk from a mammal (i.e., dairy milk). Milk from a non-animal source is generally referred to as non-dairy milk. Plant-based milk is a type of non-dairy milk.

Herein, “mouthfeel” refers to physical sensations in an individual's mouth caused by food, as opposed to taste of the food. In combination with taste and smell, mouthfeel determines the overall flavor of a food. Mouthfeel is sometimes also called “texture”.

Herein, “mutton” refers to flesh from a mature sheep, used as a food. Herein, flesh from a young sheep, used as food, may be referred to as “lamb.”

The term “non-dairy” as used herein means that the product or formulation has no dairy-based ingredients or less than 0.5% by weight of dairy-based ingredients. The term “substantially non-dairy” as used in the present disclosure means that the product or formulation has less than 5% by weight of dairy-based ingredients.

Herein, “nongluten” or “gluten free” means lacking or having a reduced amount of gluten.

Herein, “particle,” refers to a small, localized object or entity.

Herein, “particle size” generally refers to a Dx50 measurement (e.g., in μm) for a population of particles having a distribution of sizes.

Herein, “patty” refers to a small, generally flat cake of minced or finally chopped food. Herein, patties are generally meat analogue patties or meat hybrid patties.

Herein, “pork” refers to flesh of a pig, used as a food.

Herein, “product” refers to something that is made or processed.

Herein, “protein” refers to a chain or polymer of amino acids, covalently joined by peptide bonds.

Herein, “refined protein” refers to isolated protein that has been processed.

Herein, “resilience” is how well a food regains its original height after compression. Resilience may be determined using texture profile analysis (TPA) testing.

Herein, “salt” refers to a compound made by joining a positively charged acid with a negatively charged base.

Herein, “salt-precipitated protein” refers to refined plant protein made by the process described herein and in U.S. Patent Publication No. 2019/0000112 A1 (Ser. No. 16/068,567), published Jan. 3, 2019 and titled, “Product Analogs or Components of Such Analogs And Processes For Making Same.” Protein prepared using a process for salt precipitation that uses, for example, a calcium salt may be called “calcium-precipitated protein.”

Herein, “shape” refers to a defined external form or outline. At least for the meat analogues disclosed herein, common shapes include bars, balls, chunks, fibers, granules, nuggets, shreds, slices, sticks and so forth. A meat analogue that possesses a particular shape may have been given or made into the shaped by a process that may be referred to as “shaping.”

Herein, “shellfish” refers to aquatic shelled mollusks or crustaceans.

Herein, “solid” refers to firm and stable in shape; not liquid or fluid.

Herein, “solution pH” refers to pH of water into which an amount of refined protein preparation has been dissolved. Herein, the pH of 10% (w/w) supersaturated solutions of refined protein preparations were determined.

Herein, “source,” refers to the origin of something or the place where something was obtained.

Herein, “springiness” is the degree to which food returns to its original dimensions after being compressed. Springiness may be determined using texture profile analysis (TPA) testing.

Herein, “starch” refers to D-glucose units joined by α(1→4)-glycosidic bonds. Starch contains amylose and amylopectin.

Herein, “sugar” refers to sweet-tasting, soluble carbohydrates. Some example sugars include the disaccharides, sucrose (glucose and fructose) lactose (glucose and galactose) and maltose (two molecules of glucose). Example simple sugars, called monosaccharides, include glucose, fructose, allulose, and galactose. Generally, sugars are sweetening agents.

Herein, “sweetening agent” refers to a substance capable of imparting a taste or flavor characteristic of sugar, honey, and the like, to food. Sweetening agents may include non-caloric sweeteners such as aspartame, saccharin, stevia, monk fruits and protein-based sweeteners. Sweet is a taste sensation that is not bitter, sour or salty.

Herein, “texture” means the appearance, feel and/or consistency of a substance or surface. Regarding food, texture may be defined as the properties of a food that include physical characteristics that come from structural elements of the food which are generally sensed by touch and are related to deformation, disintegration and flow of the food under a force. Some parameters of texture include adhesiveness, chewiness, cohesiveness, fracturability, gumminess, hardness, resilience and springiness. Some parameters of texture may include Max Force, Toughness and/or Distance to Failure, as described in Example 4. In some examples, some of these parameters may be determined by a Texture Profile Analysis (TPA), using an example instrument called a texture analyzer. Also see “mouthfeel” herein. A variety of other terms may be used to describe texture, including, but not limited to dense, dry, firm, juicy, moist, oily, pasty, soft and the like.

Herein, “thickening agent” refers to a substance that increases the viscosity of a liquid. Generally, thickening agents increase viscosity without substantially changing other properties of the liquid. The thickening agents referred to in this application are generally edible thickening agents. In some examples, the thickening agents used herein may dissolve in a liquid as a colloid that forms a cohesive internal structure (e.g., a gel).

Herein, “turkey” refers to the bird and/or flesh from the bird, used as a food.

Herein, “vegan” means using or containing no animal products. Vegan normally excludes eggs. Vegan that includes eggs may be called “ovo-vegetarian.”

Herein, “vegetable” means any plant, part of which is used for food or an edible part of a plant. Vegetable may also be defined as any plant part consumed for food that is not a fruit or seed but including mature fruits that are eaten as part of a main meal.

Herein, “vegetarian” means using or containing no meat (also excluding fish and poultry). Vegetarian does not exclude eggs.

Herein, “venison” refers to flesh from a deer, used as a food.

### High Moisture Extrudates (HMEs), High Moisture Meat Analogues (HMMAs) and High Moisture Extrusion Cooking (HMEC)

Meat analogues are meat-like substances that typically have an appearance, flavor and/or texture of real meat, but are not from the flesh of an animal. An example type of meat analogue is a high moisture meat analogue (HMMA). HMMAs may have as an ingredient a high moisture extrudate (HME). HMEs generally are made by a high moisture extrusion cooking (HMEC) process. The HMEC process generally uses an extruder, often a twin-screw extruder. Herein, in making HMEs, a protein preparation (e.g., isolated protein or refined protein) and other ingredients to be included in the HME are fed into the extruder and water is injected into the extruder. Inside the extruder, the mass is subjected to heat, hydration, pressure, and mechanical energy. While not wishing to be held to a mechanism, it is thought that, during the process, input proteins are hydrated, denatured, degraded and/or plasticized. In some examples, the mass may reach temperatures over 150° C. As the mass is pushed through the extruder, into the die, the mass forms a laminar flow, cools and the proteins are thought to realign. The mass becomes solid and forms into meat-like structures. The mass exits the die as a continuous, generally rubbery-like strand or ribbon. The product is called HME.

Herein, the ingredients of the HMEs generally include non-meat or plant protein, which may be salt-precipitated protein or may not be salt precipitated. The proteins generally are acidic. In some examples, these proteins may be about or less than about pH 7.1, 7.0, 6.9, 6.8, 6.7, 6.6, 6.5, 6.4, 6.3, 6.2, 6.1, 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 6.5, 3.4, 3.3, 3.2, 3.1, 3.0, 2.9, 2.8, 2.7, 2.6, 2.5, 2.4, 2.3, 2.2, 2.1 or 2.0. In some examples, the proteins may be between about pH 3 to 7. In some examples, the HMEs may include additional protein, perhaps from another source and perhaps protein that is not at an acidic pH. In some examples, these proteins may be from legumes, including pea. In some examples, these proteins may be from faba or fava beans. However, as described elsewhere herein, proteins may be from many sources, including many different plant sources. In some examples, other ingredients may be added to the HMEC process (e.g., coloring agents).

Generally, the amount of an ingredient or ingredients is given in “percent by weight” or “weight percent” of the composition. Herein, for an HME, the ingredients and amount of the ingredients generally refers to what is introduced into the extruder. Because water/steam is separately introduced into the extruder, and because of the introduced energy that is part of the HMEC process, the composition of the HME generally is not the same as the ingredients/amount of ingredients that are input. Generally, the extruded HMEs contain significant moisture that is not present in the ingredients fed into the extruder. Rather, the moisture in the extruded HMEs comes from the water/steam introduced by the extruder into the HMEC process. In some examples, the moisture in the extrudate may be 50 percent by weight of the extrudate. In such an example, the amount of an ingredient input into the extruder (e.g., 90 percent by weight of a refined protein preparation, which itself may be at least 80 percent by weight) may be 45 percent by weight. Properties and characteristics of the final HME generally also depend on the parameters used for the HMEC process.

In some examples, the ingredients fed into an extruder for the HMEC process may include between about 40-100, 50-100, 60-100, 70-100, 79-100, 80-100, 90-100 or 95-100 percent by weight of the acidic protein. In some examples, additional protein may be used at between 0-10, 0-15, 0-20, 0-25, 0-30, 0-35, 0-36, 0-45, 0-50, 0-55, 0-60, 1-10, 1-15, 1-20, 1-25, 1-30, 1-35, 1-36, 1-45, 1-50, 1-55 or 1-60 percent by weight. In some examples, the acidic protein may be the only protein used in the process and may be used at about 80, 85, 90, 95, 96, 97, 98, 99 or 100 percent by weight.

In some examples, between about 0-1 percent by weight of coloring agents may be used.

Generally, the ingredients fed into the extruder for the HMEC may include between about 75-100, 80-100, 85-100, 90-100, 92-100, 95-100, 96-100, 97-100, 98-100 or 99-100 percent by weight of protein.

In some examples, the composition of the HMEs resulting from the HMEC wet extrusion process may be about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 percent by weight of protein.

In some examples, the composition of HMEs resulting from the HMEC wet extrusion process may be about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79 or 80 percent by weight of water.

In addition to the ingredients that are fed into the extruder, properties of the extruded HME may depend on the conditions of the HMEC process, which in part depend on the parameters programmed into the extruder device. Example parameters for the process may include, but not be limited to, the rate at which the ingredients and/or water or steam is fed into the extruder, the temperature(s) of various sections of the extruder, the temperature of the die, the amount of energy used in the cooking process, the rate at which the mass moves through the extruder, the rate and extent to which the mass is cooled, and the like. Parameters for an example HMEC process used herein are shown in Table 3 in Example 2.

In some examples, this disclosure relates to meat analogues that may be HMEs. However, this disclosure also discloses meat analogues and meat hybrids that use HMEs as an ingredient. These meat analogues and meat hybrids contain ingredients in addition to the HME ingredient, which generally are used for the purpose of creating meat analogues that have properties (e.g., appearance, aroma, taste, texture and the like) that are more meat-like. Examples of these additional ingredients, and examples of how they are used to produce the disclosed meat analogues and meat hybrids, are described and set forth in the remainder of this disclosure.

### Ingredients

In some examples, the ingredients used in the meat analogues disclosed herein may include various carbohydrates, non-dairy and/or plant-based protein, plant-based fats, including plant-based oils, emulsifiers, sweetening agents, salt, thickening agents, flavoring agents (natural and/or artificial), binding agents, coloring agents, water, vitamins and/or other nutritional supplements, enzymes, and other ingredients.

Herein, for meat analogues and meat hybrids made using HMEs as an ingredient, the ingredients of the meat analogue or meat hybrid are given in “percent by weight” or “weight percent” of the composition.

Generally, the ingredients described in the sections below are grouped by chemical category (e.g., starch, protein). In some examples, however, ingredients are grouped in functional categories (e.g., emulsifier, flavoring agent, sweetening agent). In some examples, an ingredient grouped in a chemical category may have one or more activities of one or more of the functional categories (e.g., some starches may have emulsifier activity), even though the ingredient is not listed as part of the functional category. In some examples, an ingredient grouped in a functional category may contain chemical substances that could be grouped into one or more chemical categories. In some examples, an ingredient grouped in a chemical category may contain substances from one or more other chemical categories. In some examples, an ingredient grouped in a functional category may have at least some activity that could be grouped in other functional categories. Grouping an ingredient in one category does not preclude that it may have chemical composition and/or activity that could be classified in a different category.

In some examples, the meat analogues disclosed herein may include about or no more than about 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 400, 405, 410, 415, 420, 425, 430, 435, 440, 445 or 450 calories per 113 grams of the meat analogues or meat hybrids.

### Carbohydrates

Herein, “carbohydrate” includes sugars, starch and cellulose. Carbohydrates may be monosaccharides, disaccharides, oligosaccharides or polysaccharides. Sugars may include polyols/sugar alcohols. Carbohydrates may be digestible or may be indigestible or poorly digestible. Herein, carbohydrates are generally from non-animal sources. In some examples, the carbohydrates used in the meat analogues disclosed herein may be from plant sources. Carbohydrates may function as sweeteners, binders, fiber sources, moisture-holders, texture-modifiers, and may serve other functions in the disclosed analogues. In some examples, a single source of carbohydrate may be used in the disclosed meat analogues. In some examples, 2, 3, 4, 5, 6, 7, 8, 9 or 10 different sources and/or types of carbohydrates may be used in the disclosed meat analogues.

In some examples, the carbohydrates used herein may be from any plant source. In some examples, the carbohydrates used herein may be from arracacha, arrowroot, canna, cassava (e.g., tapioca), chickpeas, corn, fava or faba beans, lentils, maize, mung beans, peas, maize, millet, nuts, potatoes, rice, sago, sorghum, sweet potatoes, taro root, rye, yams, waxy maize, soy and others.

In some examples, the carbohydrates used herein may specifically exclude one or more plant sources. In some examples, the carbohydrates used in the meat analogues disclosed herein may exclude one or more of carbohydrates from arracacha, arrowroot, canna, cassava (e.g., tapioca), chickpeas, corn, fava or faba beans, lentils, maize, mung beans, peas, maize, millet, potatoes, rice, sago, sorghum, sweet potatoes, taro root, rye, yams, waxy maize, soy and others.

Carbohydrates may be in solid or liquid form. Carbohydrates may be water soluble or non-water soluble. Carbohydrates may be in the form of a flour. Carbohydrates may be in the form of a meal. Carbohydrates may be in the form of a powder. Carbohydrates may be in the form of a syrup. Carbohydrates may be in other forms. In some examples, carbohydrates in one or more of the indicated forms may be specifically excluded from use in the meat analogues disclosed herein.

In some examples, flour may be sourced from one or more of the plant sources listed above. In some examples, flour may be sourced from cereal grains or other starchy food sources, like almond, amaranth, arrowroot, atta, banana, barley, buckwheat, cassava, chickpea, coconut, corn (e.g., cornstarch or fine cornmeal), fava or faba bean, millet, mung bean, nuts (e.g., Brazil nut, cashew, macadamia, pistachio), oats, quinoa, potatoes, rice, rye, spelt, sorghum, soybean, sweet potatoes, taro root, teff, triticale, wheat, yellow pea, urad dal, and others. In some examples, flour from one or more of these sources may be specifically excluded from use in the disclosed meat analogues. In some examples, flour may be from non-allergenic or hypoallergenic sources. Flour generally may contain carbohydrate. Flour may contain protein.

Non-limiting types of flour used may include all-purpose flour, cake flour, germ flour, graham flour, maida, pastry flour, self-rising flour, white flour, whole wheat flour, and others. One or more types of these flours may be excluded from use in the meat analogues disclosed herein.

Example carbohydrates used in the disclosed meat analogues may include corn syrup, corn fiber, high fructose corn syrup, tapioca syrup, crystalline fructose, tagatose, sucrose, lactose, maltose, galactose, xylose, dextrose, cyclodextrins, trehalose, raffinose, stachyose, fructooligosaccharide, maltodextrins, starches, pectins, gums, carrageenan, inulin, or cellulose based compound, or various sugar alcohols, including sorbitol, mannitol, maltitol, xylitol, lactitol, isomalt, erythritol or others.

Example carbohydrates used in the disclosed meat analogues may include glucose, sucrose, fructose, dextrose, lactose and maltose. Carbohydrate sucrose, cocoa butter, high-fructose corn syrup, peanut butter, nuts, maltodextrins, isomaltulose, maltitol syrups, sorbitol syrups and mixtures thereof. Example carbohydrates used in the disclosed meat analogues may include polydextrose, xylose, xylitol, sorbitol, cyclodextrins, trehalose, raffinose, stachyose, fructooligosaccharide, maltose, pectins, gums, carrageenan, inulin, hydrogenated indigestible dextrins, hydrogenated starch hydrolysates, highly branched maltodextrins and celluloses.

The carbohydrate preparations used herein as ingredients of the meat analogues disclosed herein may contain about or at least about 1, 2, 3, 4, 5, 6, 7, 8, 9, 10, 11, 12, 13, 14, 15, 20, 25, 30, 35, 40, 45, 50, 55, 60, 65, 70, 75, 76, 77, 78, 79, 80, 81, 82, 83, 84, 85, 86, 87, 88, 89, 90, 91, 92, 93, 94, 95, 96, 97, 98 or 99 percent by weight carbohydrates. In some examples, the meat analogues disclosed herein may contain or may contain no more than 0, 1, 2, 3, 4, 5, 6, 7, 8, 9, 10, 11, 12, 13, 14, 15, 16, 17, 18, 19, 20 or more percent by weight carbohydrates.

The carbohydrate ingredients may contain other components like, for example, ash, calcium, fat, heavy metals, iron, magnesium, potassium, protein, sodium, vitamins and others.

In some examples, the carbohydrates used herein may be modified. Starch, for example, may be modified by physical and/or chemical means. Some examples of physical modification may include superheating, dry heating, osmotic pressure treatment, multiple deep freezing and thawing, instantaneous controlled pressure-drop process, stirring ball milling, vacuum ball milling, pulsed electric fields treatment, corona electrical discharges and others. Chemical modification may include adding new or modifying existing moieties in the carbohydrate. In some examples, the modifications may be introduced at hydroxyl groups of carbohydrates. Modifications may involve chemical derivatization, like etherification, esterification, acetylation, cationization, oxidation, hydrolysis, cross-linking and others.

Modified starch, for example, may have enhanced properties. Example enhanced properties may include enhancements in binding, color, dispersion, emulsion stabilization and/or encapsulation, flavor, gelling, melting, solubility, texture, thermal stability, viscosity and others.

The starch used in the meat analogues may be a single type of starch (e.g., from a particular plant, or a particular commercial source) or may be combinations of multiple types of starch, for example, 2, 3, 4, 5, 6, 7, 8, 9, 10 or more types of starch. In some examples, one or more specific starches may be excluded.

In some examples, carbohydrates may be included in the meat analogue or hybrid meat formulations and/or final meat analogues or meat hybrids at amounts that are about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84 or 85 percent by weight of the meat analogue.

In some examples, carbohydrates may be included in the meat analogue or hybrid meat formulations and/or final meat analogues or meat hybrids at amounts that are no more than, or no less than, about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 percent by weight of the meat analogue.

In some examples, carbohydrates may be included in the meat analogue or hybrid meat formulations and/or final meat analogues or meat hybrids at amounts that are about or between about 1-80 percent by weight. In some examples, starch may be included at amounts about or between about 0-1, 0-2, 0-3, 0-4, 0-5, 1-40, 2-60, 2-55, 2-50, 2-45, 2-40, 2-38, 2-35, 3-30, 3-36, 4-60, 4-55, 4-50, 4-45, 4-40, 4-35, 4-30, 4-25, 5-32, 6-60, 6-55, 6-50, 6-45, 6-40, 6-35, 6-30, 7-28, 8-26, 8-24, 8-20, 8-16, 9-30, 9-28, 9-24, 10-35, 10-30, 10-28, 10-25, 10-22, 10-20, 10-14, 11-35, 11-30, 11-25, 11-20, 11-15, 12-30, 12-25, 12-20, 12-18, 13-45, 13-35, 13-30, 13-25, 13-20, 14-30, 14-28, 14-26, 14-24, 14-22, 15-30, 15-25, 15-20, 16-25, 17-25, 17-20, 18-25, 18-24, 20-25 percent by weight and others.

In some examples, carbohydrates may be present in meat analogue or hybrid meat formulations and/or meat analogues or meat hybrids at about 1, 2, 3, 4, 5, 6, 7, 8, 9, 10, 11, 12, 13, 14, 15, 16, 17, 18, 19, 20, 21, 22, 23, 24, 25 or more grams per 113 grams of meat analogue or meat hybrid.

In some examples, maltodextrin may be used as an ingredient of the meat analogues disclosed herein. In some examples, maltodextrin may be used at amounts about or between about 1-5 percent by weight.

### Isolated and Refined Protein

Herein, “protein” refers to a chain or polymer of amino acids, covalently joined by peptide bonds. Herein, proteins are generally non-dairy proteins. Generally, proteins used in the meat analogues containing non-dairy proteins described herein are from plants. Proteins from any plant may be used in the meat analogues described herein. Various plant proteins used may be from almond, barley, canola, carrot, cabbage, celery, cereal, chickpea, coconut, emmer, fennel, flax, fava bean, garbanzo bean, lettuce, lupin seeds, melon, mushroom, navy bean, oat, pea, pear, potato, quinoa, rapeseed, rice, sesame, soybean, sunflower, wheat, white bean, yellow pea and others. In some examples, proteins used in the meat analogues are from legumes. Plant proteins may be from one type of plant or from multiple plants. Other suitable plant protein isolates are also acceptable. In some examples, the plant protein component may include gluten as part of the plant protein. In some examples, the meat analogues disclosed here do not contain gluten.

In some examples, meat analogues disclosed herein may contain proteins from only one plant protein source. In some examples, the meat analogues may contain proteins from 2, 3, 4, 5, 6, 7, 8, 9 or 10 plant protein sources.

In some examples, specific sources of plant proteins may be excluded from the plant proteins used in the meat analogues disclosed herein. In some examples, plant proteins from one, or from 2, 3, 4, 5, 6, 7, 8, 9, 10 sources may be excluded from the meat analogues disclosed herein. In some examples, plant proteins from one, or more or all of the following plants may be specifically excluded: almond, barley, canola, carrot, cabbage, celery, cereal, chickpea, coconut, emmer, fennel, flax, fava bean, garbanzo bean, lettuce, lupin seeds, melon, mushroom, navy bean, oat, pea, pear, potato, quinoa, rapeseed, rice, sesame, soybean, sunflower, wheat and white bean.

In some such examples, the protein may be from a legume. Generally, any edible legume may be used as a source of protein. In some examples, proteins from one or more specific legumes may be excluded.

In some examples, legumes may include aburaage, adzuki beans, alfalfa, anasazi beans, asparagus beans, awase miso, azufrado beans, barley miso, bayo beans, beans, bean curd skin, black adzuki beans, black beans, black chickpeas, black kidney beans, black nightfall beans, black valentines beans, black lentils, black soybeans, black turtle beans, bolita beans, bonavist beans, borlotti beans, bountiful beans, brown lentils, brown speckled cow beans, broad beans, butter beans, calypso beans, canary beans, cannellini beans, carob, chickpeas, christmas lima beans, climbing French beans, clover, cowpeas, crab eye beans, dark red kidney beans, dwarf peas, English peas, European soldier beans, eye of goat beans, fava beans, fayot, flageolet beans, garden peas, great norther beans, hyacinth bean, inariage, Jackson wonder lima bean, kidney bean, kinugoshi, koya-dofu, lablab, lentils, licorice, lima beans, lingot beans, lupins, lupin seeds, Maine yellow eye beans, mayocoba beans, mesquite, molasses face beans, mortgage lifter beans, mung beans, natto, navy beans, okara, ocra beans, otebo beans, peanuts, peas, pigeon peas, pink beans, pink lentils, pinto beans, potato beans, puy lentils, rattlesnake beans, red beans, red eye beans, red lentils, red miso, roman beans, salugia beans, scarlet runner beans, shelling peas, small red beans, small white beans, snow peas, sourthern peas, soybeans, Steuben yellow beans, sugar snap peas, tamarind, tempeh, tongue of fire beans, trout beans, turtle beans, usuage, vallarta beans, vaquero beans, winged beans, yellow lentils, yellow miso, yin yang beans, yuba yellow indian women beans, and others.

In some examples, plant proteins from one, or more or all of the following legumes may be specifically excluded from the meat analogues disclosed herein: aburaage, adzuki beans, alfalfa, anasazi beans, asparagus beans, awase miso, azufrado beans, barley miso, bayo beans, beans, bean curd skin, black adzuki beans, black beans, black chickpeas, black kidney beans, black nightfall beans, black valentines beans, black lentils, black soybeans, black turtle beans, bolita beans, bonavist beans, borlotti beans, bountiful beans, brown lentils, brown speckled cow beans, broad beans, butter beans, calypso beans, canary beans, cannellini beans, carob, chickpeas, christmas lima beans, climbing French beans, clover, cowpeas, crab eye beans, dark red kidney beans, dwarf peas, English peas, European soldier beans, eye of goat beans, fava beans, fayot, flageolet beans, garden peas, great norther beans, hyacinth bean, inariage, Jackson wonder lima bean, kidney bean, kinugoshi, koya-dofu, lablab, lentils, licorice, lima beans, lingot beans, lupins, lupin seeds, Maine yellow eye beans, mayocoba beans, mesquite, molasses face beans, mortgage lifter beans, mung beans, natto, navy beans, okara, ocra beans, otebo beans, peanuts, peas, pigeon peas, pink beans, pink lentils, pinto beans, potato beans, puy lentils, rattlesnake beans, red beans, red eye beans, red lentils, red miso, roman beans, salugia beans, scarlet runner beans, shelling peas, small red beans, small white beans, snow peas, sourthern peas, soybeans, Steuben yellow beans, sugar snap peas, tamarind, tempeh, tongue of fire beans, trout beans, turtle beans, usuage, vallarta beans, vaquero beans, winged beans, yellow lentils, yellow miso, yin yang beans and yuba yellow indian women beans, and others.

In some examples, the protein may be hypoallergenic or non-allergenic protein. Of note is that pea protein is not among the 8 significant food allergens recognized in the United States, which include milk, eggs, fish, crustacean shellfish, tree nuts, peanuts, wheat and soybeans. Pea protein is not among the 14 significant food allergens recognized in Europe. One example hypoallergenic/non-allergenic protein, therefore, includes protein sourced from pea. In some examples, the hypoallergenic or non-allergenic protein may be sourced from hemp, chia, spirulina, quinoa, teff, amaranth, buckwheat and millet. Other hypoallergenic/non-allergenic plant proteins are known in the art.

In some examples, the protein may be lupine protein, including pea or yellow pea. The pea may be whole pea or a component of pea, standard pea (i.e., non-genetically modified pea), commoditized pea, genetically modified pea, or combinations thereof. In some examples, the pea may be Pisum sativum.

In some examples, the meat analogues disclosed herein may contain no other protein or no other plant protein, except protein from peas or protein from yellow peas. In some examples, the meat analogues disclosed herein may contain no other protein or no other plant protein, except protein from Pisum sativum.

In some examples, the protein may be from soy. The soy may be whole soy or a component of soy, standard soy (i.e., non-genetically modified soy), commoditized soy, genetically modified soy, or combinations thereof.

In some examples, the protein may be from chickpea. The chickpea may be whole chickpea or a component of chickpea, standard chickpea (i.e., non-genetically modified chickpea), commoditized chickpea, genetically modified chickpea, or combinations thereof.

In some examples, the protein may be from one or more microbes, including yeast.

Plant protein (e.g., isolated protein) may contain components that negatively affect taste, texture and/or other properties of meat analogues made using the protein. In some examples, the isolated protein preparation may be processed for various purposes, such as to remove components like aroma agents, coloring agents, flavoring agents and other components. In some examples, the protein may be extracted in a solvent to remove lipids and/or heat treated to remove volatiles. Examples of treatments to obtain refined protein are described in the next section of this application.

In some examples, the refined protein may have an aqueous solubility of about 50, 45, 40, 35, 30, 25, 20, 15, 10, 9, 8, 7, 6, 5, 4, 3, 2 or 1 percent (w/w). In some examples, the refined protein may have an aqueous solubility of no more than or less than about 15, 14, 13, 12, 11, 10, 9, 8, 7, 6, 5, 4, 3, 2 or 1 percent (w/w).

Herein, pH of protein preparations is determined by dissolving protein in water to obtain a 10% (w/w) solution and then determining pH of the solution (i.e., solution pH). In some examples, the refined protein may have a solution pH of about or less than about or no more than 8.0, 7.9, 7.8, 7.7, 7.6, 7.5, 7.4, 7.3, 7.2, 7.1, 7.0, 6.9, 6.8, 6.7, 6.6, 6.5, 6.4, 6.3, 6.2, 6.1, 6.0, 5.9, 5.8, 5.7, 5.6, 5.5, 5.4, 5.3, 5.2, 5.1, 5.0, 4.9. 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1 or 2.0. Generally, the solution pH of the salt-precipitated protein is acidic. In some examples, the refined protein may have a solution pH of about 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7 or 6.8. In some examples, the refined protein may have a solution pH of less than about 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7 or 6.8. In some examples, the refined protein may have a solution pH in the range of about 2.0-3.0, 2.0-3.5, 2.0-4.0, 2.0-4.5, 2.0-5.0, 2.0-5.5, 2.0-6.0, 2.0-6.5, 2.5-3.0, 2.5-3.5, 2.5-4.0, 2.5-4.5, 2.5-5.0, 2.5-5.5, 2.5-6.0, 2.5-6.5, 3.0-3.5, 3.0-4.0, 3.0-4.5, 3.0-5.0, 3.0-5.5, 3.0-6.0, 3.0-6.5, 3.5-4.0, 3.5-4.5, 3.5-5.0, 3.5-5.5, 3.5-6.0, 3.5-6.5, 4.0-4.5, 4.0-5.0, 4.0-5.5, 4.0-6.0, 4.0-6.5, 4.5-5.0, 4.5-5.5, 4.5-6.0, 4.5-6.5, 5.0-5.5, 5.0-6.0, 5.0-6.5 or 6.0-6.5.

In some examples, the refined protein may have a sodium content of about or less than about or no more than 8000, 7500, 7000, 6500, 6000, 5500, 5000, 4900, 4800, 4700, 4600, 4500, 4400, 4300, 4200, 4100, 4000, 3900, 3800, 3700, 3600, 3500, 3400, 3300, 3200, 3100, 3000, 2900, 2800, 2700, 2600, 2500, 2400, 2300, 2200, 2100, 2000, 1900, 1800, 11700, 1600, 1500, 1400, 1300, 1200, 1100, 1000, 950, 940, 930, 920, 910, 900, 890, 880, 870, 860, 850, 840, 830, 820, 810, 800, 790, 780, 770, 760, 750, 740, 730, 720, 710, 700, 690, 680, 670, 660, 650, 640, 630, 620, 610, 600, 590, 580, 570, 560, 550, 540, 530, 520, 510, 500, 490, 480, 470, 460, 450, 440, 430, 420, 410, 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 90, 80, 70, 60, 50, 40, 30, 20 or 10 parts per million (ppm).

The refined protein preparation may have various forms, including, but not limited to concentrate, flour, isolate, meal, paste, powder and others. The protein may be native, denatured or renatured; dried, spray dried, or not dried protein; enzymatically treated or untreated protein; and combinations thereof. The protein may consist of particles of one or more sizes and may be pure or mixed with other components (e.g., other plant source components).

In some examples, proteins processed by specific methods may be excluded from the meat analogues disclosed herein. In some examples, proteins having specific forms (e.g., concentrate, flour, isolate, meal, paste, powder) may be excluded from the meat analogues disclosed herein. In some examples, proteins that are denatured, renatured; dried, spray dried; enzymatically treated; of specific sizes; and/or mixed with other components, may be specifically excluded from the meat analogues disclosed herein.

In some examples, the processed or refined protein may contain at least 10, 20, 30, 40, 50, 60, 70, 80 or 90% by weight of protein. The processed or refined protein may contain a percent by weight of protein of between 10-30, 10-20, 12-16, 20-99, 20-60, 25-95, 30-90, 30-50, 40-99, 40-95, 40-90, 40-85, 40-80, 40-75, 50-99, 50-95, 50-90, 50-85, 50-80, 60-99, 60-95, 60-90, 60-85, 60-80, 60-75, 65-99, 65-95, 65-90, 65-85, 65-80, 70-99, 70-95, 70-90, 70-85, 70-80, 75-99, 75-95, 75-90, 75-85, 75-80 and others.

In some examples, the processed/refined protein may contain carbohydrates and/or fat. In some examples, the processed/refined protein may contain calcium, phosphorous, potassium, sodium, and other cations. In some examples, the processed/refined protein may contain ash.

In some examples, the meat analogues disclosed herein may specifically exclude one or more cations and/or ash.

In some examples, the refined protein may have a carbohydrate content of between 0-50% by weight. In some examples, the refined protein may have a carbohydrate content of at least 0% by weight. In certain examples, the refined protein may have a carbohydrate content of less than 25% by weight.

In some examples, the refined protein may have a starch content of between 0-10% by weight. In some examples, the refined protein may have a starch content of at least 3% by weight. In some examples, the refined protein may have a starch content of less than 9% by weight.

In some examples, the refined protein may have a fat content of between 1-30% by weight. In some examples, the refined protein may have a fat content of at least 2% by weight. In some examples, the refined protein may have a fat content of less than 25% by weight.

In some examples, the refined protein may have a calcium content of between 0-5% by weight. In some examples, the calcium content may be between about 0.1 and 2% by weight.

In some examples, the refined protein may have a phosphorus content of between 0-6% by weight. In some examples, the phosphorus content may be at least 0.1% by weight. In some examples, the refined protein may have a phosphorus content of less than 4% by weight.

In some examples, the refined protein may have a potassium content of less than 0.5% by weight.

In some examples, the refined protein may have an ash content of between 0-20% by weight. In some examples, the refined protein may have an ash content of at least 1% by weight.

In some examples, the refined protein may be in the form of granules. In some examples, the refined protein may be in the form of a powder. In some examples, the refined protein may be in the form of a granulated powder. In some examples, the refined protein may be a flour. In some examples, the size of particles or the mean size of particles in these forms of refined protein may be between 1 and 1000 μm, 10 and 500 μm, 50 and 350 μm, 70 and 250 μm or 100 and 150 μm. In some examples, the mean size of particles in a distribution of the particles may be about 0.1, 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 μm in size. In some examples, at least 10, 20, 30, 40, 50, 60, 70, 80, 90 or 95% of the particles these forms of refined protein may be about 0.1, 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 μm in size.

In some examples, a particle size distribution for the protein particles may be Dx50 of about or less than about 200, 190, 180, 170, 160, 150, 140, 130, 120, 110, 100, 90, 80, 70, 60, 50, 40, 30, 20 or 10 μm.

In some examples, adsorption of water, the amount of water adsorbed, the rate at which water is adsorbed, and the like, may be affected by the size of the protein particles. In some examples, things like the amount and/or rate of water adsorption may be related to or proportional to the surface area, volume, surface area per unit volume, and the like, of the protein particles (e.g., granules, powder, granulated powder). In some examples, this may not be the case.

In some examples, the water holding capacity of refined protein may be tested. In some examples, the water holding capacity of refined protein may be tested as described in Example 1. In some examples, the water holding capacity of the refined protein may be less than about 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1 or 2.0 g water/g protein preparation. In some examples, the water holding capacity of the refined protein may be about 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1 or 2.0 g water/g protein preparation. In some examples, the water holding capacity of the refined protein may be between about 1.6-2.2, 1.6-2.3, 1.6-2.4, 1.6-2.5, 1.6-2.6, 1.6-2.7, 1.6-2.8, 1.7-2.2, 1.7-2.3, 1.7-2.4, 1.7-2.5, 1.7-2.6, 1.7-2.7, 1.7-2.8, 1.8-2.2, 1.8-2.3, 1.8-2.4, 1.8-2.5, 1.8-2.6, 1.8-2.7, 1.8-2.8, 1.9-2.2, 1.9-2.3, 1.9-2.4, 1.9-2.5, 1.9-2.6, 1.9-2.7, 1.9-2.8, 2.0-2.2, 2.0-2.3, 2.0-2.4, 2.0-2.5, 2.0-2.6, 2.0-2.7 or 2.0-2.8 g water/g protein preparation.

In some examples, the oil holding capacity of refined protein may be tested. In some examples, the oil holding capacity of refined protein may be tested as described in Example 1. In some examples, the oil holding capacity of the refined protein may be less than about 1.2, 1.1, 1.0, 0.9, 0.8 or 0.7 g oil/g protein preparation. In some examples, the oil holding capacity of the refined protein may be about 1.2, 1.1, 1.0, 0.9, 0.8 or 0.7 g oil/g protein preparation. In some examples, the oil holding capacity of the refined protein may be between about 0.8-1.1, 0.8-1.0, 0.8-0.9, 0.9-1.1, 0.9-1.0 or 1.0-1.1 g oil/g protein preparation.

The protein preparations used herein may have some binder activity. The protein preparations used herein may have some emulsifier activity.

In some examples, at least some of the protein in the disclosed meat analogues may be from eggs. In some examples, the meat analogues disclosed herein may not contain eggs. In some examples, the meat analogues disclosed herein may specifically exclude egg protein.

In some examples, the refined protein may have certain color values. In some examples, the refined protein may be color neutral. In some examples the refined protein may have L* values of greater than 65, 70, 75, 76, 77, 78, 79, 80, 81, 82, 83, 84, 85, 86, 87 or 88. In some examples, the L* values may be between about 60-90, 65-90, 70-90, 75-90 or 80-90.

In some examples, the refined protein may have a* values between about +6 to −6, +5 to −5, +4 to −4, +3 to −3 or +2 to −2.

In some examples, the refined protein may have b* values of between about +30 to −30, +25 to −25, +20 to −20, +19 to −19, +18 to −18, +17 to −17 or +16 to −16.

In some examples, the refined protein may have a combination of any of the L*, a* and b* values as set forth above. In some examples, the refined protein may have L* of between about 76-80, a* of between about −2.5 to −0.7, and b* of between about +4.5 to +12.

In some examples, the refined protein may be subjected to rapid visco analyzer (RVA) testing. In some examples, the RVA testing may be conducted under conditions as described in Example 1. In some examples, the final viscosity (cP) of the refined protein after RVA testing may be less than about 1200, 1100, 1000, 900, 800, 700, 600, 500, 400, 300, 200 or 100. These final viscosities may be obtained when the samples tested (e.g., 6 g of protein with 25 g of water) have a pH of less than about 7.5, 7.4, 7.3, 7.2, 7.1, 7.0, 6.9, 6.8, 6.7, 6.6, 6.5, 6.4, 6.3, 6.2, 6.1, 6.0, 5.9, 5.8, 5.7, 5.6, 5.5, 5.4, 5.3, 5.2, 5.1 or 5.0. These final viscosities may be obtained when the samples tested have a pH of about 7.5, 7.4, 7.3, 7.2, 7.1, 7.0, 6.9, 6.8, 6.7, 6.6, 6.5, 6.4, 6.3, 6.2, 6.1, 6.0, 5.9, 5.8, 5.7, 5.6, 5.5, 5.4, 5.3, 5.2, 5.1 or 5.0.

In some examples, the refined protein may have a water holding capacity of less than about 2.8, 2.7, 2.6, 2.5, 2.4, 2.3, 2.2, 2.1 or 2.0 g water/g protein preparation.

In some examples, the refined protein may have an oil holding capacity of less than about 1.0, 0.9, 0.8 or 0.7 g oil/g protein preparation. In some examples, the refined protein may have an oil holding capacity of between about 0.8-0.9, 0.8-1.0 or 0.85 to 1.00 g oil/g protein preparation.

### Processes for Preparing Refined Plant Protein

Various methods may be used for obtaining refined protein components from non-animal natural protein sources. The refined protein components may be used in the meat analogues disclosed herein. However, isolated protein or non-refined protein components may also be used, exclusively or in combination with refined protein components.

Generally, the methods described below may remove or substantially remove components that may affect flavor, aroma, color and so on, from protein preparations, and thus make the refined protein preparations more suitable for use in the disclosed meat analogues. Removal of such agents may also increase the shelf life of meat analogues comprising such refined protein components.

In some examples, methods for obtaining refined protein components from non-animal natural sources may comprise one or more of the following steps, in or out of order:

a) obtaining a protein preparation from a non-animal natural source;

b) washing the protein preparation at a wash pH;

c) extracting the protein preparation at an extraction pH to obtain an aqueous protein solution;

d) separating the aqueous protein solution from non-aqueous components;

e) adding salt;

f) precipitating the protein from the aqueous protein solution at a precipitation pH to obtain a protein precipitate;

g) separating the protein precipitate from non-precipitated components; and

h) washing the protein precipitate to obtain a refined protein component.

Generally, it is at least steps (e) and (f) above that are used to prepare what is called herein as “salt-precipitated protein.” Additional steps may also be included in the process.

In some examples, the extraction and precipitation steps may be performed under heated conditions (e.g., between 50-70° C.). In some examples, at least steps (c) and (f) are performed at these temperatures. In some examples, steps (c) though (g) are performed at these temperatures. In some examples, steps (a) through (f) may be performed at these temperatures.

Washing the refined protein preparation may utilize various methods, including single wash, multiple washes, and/or counter-current washes.

The extraction pHs may be pHs that are suitable for washing and solubilizing proteins in a protein preparation. A suitable extraction pH may be determined by testing various pH conditions, and identifying the pH condition at which the most optimal yield and quality (judged by, for example by one or more of the following: flavor, odor, color, nitrogen content, calcium content, heavy metal content, emulsification activity, molecular weight distribution, and thermal properties of the protein component obtained) of the refined protein component is obtained. In some examples, the extraction pH is an alkaline pH. In some such examples, the alkaline pH is at least 7.1, at least 8, at least 9, at least 10, at least 11, at least 12, between 7.1 and 10, between 8 and 10, between 9 and 10, or between 8 and 9. In some such examples, the alkaline pH is 8.5. In some examples, the extraction pH may be an acidic pH. In some such examples, the acidic pH is less than 7, less than 6.95, less than 6.5, less than 5, less than 4, less than 3, between 2 and 6.95, between 3 and 6, or between 3 and 5. The extraction pH may be adjusted using a pH adjusting agent. In some examples, the pH adjusting agent is a food grade basic pH adjusting agent. In other examples, the pH adjusting agent is a food grade acidic pH adjusting agents. Examples of suitable acidic pH adjusting agents include, but are not limited to, phosphoric acid, acetic acid, hydrochloric acid, citric acid, succinic acid, and combinations thereof. Examples of suitable basic pH adjusting agents include, but are not limited to, potassium bicarbonate, sodium bicarbonate, sodium hydroxide, potassium hydroxide, calcium hydroxide, ethanolamine, calcium bicarbonate, calcium hydroxide, ferrous hydroxide, lime, calcium carbonate, trisodium phosphate, and combinations thereof. It may be useful to obtain substantially as much extracted protein as is practicable so as to provide an overall high product yield. The yield of protein in the aqueous protein solution may vary widely, wherein typical yields range from 1% to 90%. The aqueous protein solution typically has a protein concentration of between 1 g/L and 300 g/L. The molecular weight distribution of the proteins comprised in the aqueous protein solution may vary widely.

Separating the aqueous protein solution from non-aqueous components may be accomplished by various methods, including but not limited to, centrifugation followed by decanting of the supernatant above the pellet, or centrifugation in a decanter centrifuge. The centrifugation may be followed by disc centrifugation and/or filtration (e.g., using activated carbon) to remove residual protein source material and/or other impurities. The separation step may be conducted at various temperatures within the range of 1° C. to 100° C. For example, the separation step may be conducted between 10° C. and 80° C., between 15° C. and 70° C., between 20° C. and 60° C., or between 25° C. and 45° C. The non-aqueous components may be re-extracted with fresh solute at the extraction pH, and the protein obtained upon clarification combined with the initial protein solution for further processing as described herein. The separated aqueous protein solution may be diluted or concentrated prior to further processing. Dilution is usually affected using water, although other diluents may be used. Concentration may be affected by membrane-based methods. In some examples, the diluted or concentrated aqueous protein solution comprises between 1 g/L and 300 g/L, between 5 g/L and 250 g/L, between 10 g/L and 200 g/L, between 15 g/L and 150 g/L, between 20 g/L and 100 g/L, or between 30 g/L and 70 g/L by weight of protein.

The protein in the aqueous protein solution may be optionally concentrated and/or separated from small, soluble molecules. Suitable methods for concentrating include, but are not limited to, diafiltration or hydrocyclonation. Suitable methods for separation from small, soluble molecules include, but are not limited to, diafiltration.

Salt precipitation may be accomplished using various suitable salts and precipitation pH. Suitable salts, salt concentrations, polysaccharides, polysaccharide concentrations, and precipitation pHs may be determined by testing various conditions and identifying the salt and pH and polysaccharide conditions which obtain the most colorless and/or flavorless protein precipitates at the most optimal yield and quality (judged by, for example, by one or more of the following: flavor, odor, color, nitrogen content, calcium content, heavy metal content, emulsification activity, molecular weight distribution, and thermal properties of the protein component obtained). In some examples, salt precipitation occurs with calcium dichloride at a concentration of between 5 mM and 1,000 mM. Other examples of suitable salts include, but are not limited to, other alkaline earth metal or divalent salts (e.g., magnesium chloride, sodium chloride, calcium permanganate, and calcium nitrate). In some examples, salt is not used (e.g., the precipitation is performed at the precipitation pH without adding salt). Typically, the precipitation pH is opposite the extraction pH (i.e., when the extraction pH is in the basic range, the precipitation pH is most suitable in the acidic range, and vice versa). In some examples, the precipitation pH is an acidic pH. In some such examples, the acidic pH is less than 7.1, less than 6, less than 5, less than 4, less than 3, less than 2, between 6.9 and 2, between 6 and 3, between 6 and 5, or between 5 and 4. In some such examples, the acidic pH is 5.25. In some examples, the precipitation pH is about or less than about 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7 or 6.8. In some examples, a precipitation pH in the case where salt is included in the process step may be about 4.0-4.7. In some examples, a precipitation pH where salt is not included in the process step may be about 4.9.

The precipitation pH may be adjusted using a pH adjusting agent. In some examples, the pH adjusting agent may include phosphoric acid. In some examples, the pH adjusting agent is a food grade acidic pH adjusting agent. In other examples, the pH adjusting agent is a food grade basic pH adjusting agent.

Separating the protein precipitate from non-precipitated components may occur by one or more of the methods disclosed herein.

Washing of the protein precipitate may occur by various methods. In some examples, the washing is carried out at the precipitation pH. In some examples, the protein precipitate may not be washed.

The protein precipitate may optionally be suspended. In some examples, the suspending is carried out at the extraction pH, for example, in the presence of a chelator to remove calcium ions. If the suspended protein preparation is not transparent it may be clarified by various convenient procedures such as filtration or centrifugation.

The pH of the suspended color-neutral refined protein component (i.e., solution pH) has been described elsewhere in this document. If desired, the pH of the refined protein component may be adjusted, for example, to a pH of between 1 and 14, between 2 and 12, between 4 and 10, or between 5 and 7, by the addition of a food grade basic pH adjusting agent, including, for example, sodium hydroxide, or food grade acidic pH adjusting agent, including, for example, hydrochloric acid or phosphoric acid.

The refined protein component may be dried. Drying may be performed in a suitable way, including, but not limited to, spray drying, dry mixing, agglomerating, freeze drying, microwave drying, drying with ethanol, evaporation, refractory window dehydration or combinations thereof.

Other optional steps in the exemplary methods are heating steps aimed at removing heat-labile contaminants and/or microbial contaminations, and additional filtering (e.g., carbon filtering) steps aimed at removing additional odor, flavor, and/or color compounds. In some examples, such additional filtering is carried out immediately after extracting the protein preparation or after separating the aqueous protein solution from the non-aqueous components.

### Amounts of Protein in HMEs and Meat Analogues

In some examples, the disclosed extrusion products (HMEs) and/or the meat analogues containing HMEs are made with unrefined/non-refined proteins from plants. In some examples, the HMEs/HMMAs and/or meat analogues are made with processed/refined proteins from plants (e.g., salt-precipitated protein). In some examples, both refined protein (e.g., salt-precipitated acidic protein) and protein that is not refined may be used.

In some examples of making HMEs, protein may be included in the ingredients that are fed into the extruder to make the disclosed HMEs at about or greater than about 60, 65, 70, 75, 80, 85, 90, 91, 92, 93, 94, 95, 96, 97, 98, 99 or 100 percent by weight of the ingredients that are fed into the extruder. As discussed earlier, the percentage of protein input into the extruder may be decreased significantly in the extrudate, due to the moisture that becomes part of the product during the HMEC process. In some examples, the protein may be refined protein. In some examples, the protein may be an acidic protein preparation. In some examples, the protein may be from a single source. In some examples, the protein may be from 2, 3, 4, 5, 6, 7, 8, or 10 separate sources. In some examples, the proteins are from plant sources.

In some examples, the disclosed HMEs may be included as an ingredient of the disclosed meat analogues at amounts that are about or at least about 5, 10, 15, 20, 25, 30, 35, 40, 45, 50, 55, 60, 65, 70, 75, 80, 85, 90, 95, or 100% percent by weight of the meat analogues. In some examples, the disclosed meat analogues may contain additional protein that is not an ingredient of an HME at amounts that are about 0.5, 1, 1.5, 2.0, 2.5, 3.0, 3.5, 4.0, 4.5, 5.0, 5.5, 6.0, 6.5, 7.0, 7.5, 8.0, 8.5, 9.0, 9.5, 10, 10.5, 11.0, 11.5, 12.0, 12.5, 13.0, 13.5, 14.0, 14.5, 15.0, 15.5, 16.0 or more percent by weight of the meat analogues. In some examples, the meat analogues disclosed herein may contain HMEs as above in addition to salt-precipitated protein that is not an ingredient of an HME as above (i.e., non-HME protein).

In some examples, the meat analogues disclosed herein may contain protein at amounts that are about or at least about 10, 11, 12, 13, 14, 15, 16, 17, 18, 19, 20, 21, 22, 23, 24, 25, 26, 27, 28, 29, 30, 35, 40, 45, 50, 55, 60 or more grams per 113 grams of the meat analogue or meat hybrid. In some examples, protein may be included in the disclosed meat analogues at amounts that are about or at least about 16, 16.5, 17, 17.5, 18, 18.5, 19, 19.5, 20, 20.5, 21, 21.5, 22, 22.5, 23 or 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 36, 36.5, 37, 37.5, 38, 38.5, 49, 39.5, 40 or more grams per 113 grams of the meat analogue or meat hybrid.

In some examples, protein may be included in the meat analogue formulations and/or final meat analogue product at amounts that are about or between about 0-50 percent by weight. In some examples, protein may be included at amounts about or at least about 4, 5, 6, 7, 8, 9, 10, 11, 12, 13, 14, 15, 16, 17, 18, 19, 20, 21, 22, 23, 24, 25, 26, 27, 28, 29 or 30 percent by weight.

In some examples, protein may be included at amounts between about 5-10, 5-11, 5-12, 5-13, 5-14, 5-15, 5-16, 5-17, 5-18, 5-19, 5-20, 5-21, 5-22, 5-23, 5-24, 5-25, 5-26, 5-27, 5-28, 5-29, 5-30, 6-10, 6-11,6-12, 6-13, 6-14, 6-15, 6-16, 6-17, 6-18, 6-19, 6-20, 6-21, 6-22, 6-23, 6-24, 6-25, 6-26, 6-27, 6-28, 6-29, 6-30, 7-10, 7-11, 7-12, 7-13, 7-14, 7-15, 7-16, 7-17, 7-18, 7-19, 7-20, 7-21, 7-22, 7-23, 7-24, 7-25, 7-26, 7-27, 7-28, 7-29, 7-30, 8-10, 8-11, 8-12, 8-13, 8-14, 8-15, 8-16, 8-17, 8-18, 8-19, 8-20, 8-21, 8-22, 8-23, 8-24, 8-25, 8-26, 8-27, 8-28, 8-29, 8-30, 9-10, 9-11, 9-12, 9-13, 9-14, 9-15, 9-16, 9-17, 9-18, 9-19, 9-20, 9-21, 9-22, 9-23, 9-24, 9-25, 9-26, 9-27, 9-28, 9-29, 9-30, 10-11, 10-12, 10-13, 10-14, 10-15, 10-16, 10-17, 10-18, 10-110, 10-20, 10-21, 10-22, 10-23, 10-24, 10-25, 10-26, 10-27, 10-28, 10-210, 10-30, 11-12, 11-13, 11-14, 11-15, 11-16, 11-17, 11-18, 11-111, 11-20, 11-21, 11-22, 11-23, 11-24, 11-25, 11-26, 11-27, 11-28, 11-29, 11-30, 12-13, 12-14, 12-15, 12-16, 12-17, 12-18, 12-121, 12-20, 12-21, 12-22, 12-23, 12-24, 12-25, 12-26, 12-27, 12-28, 12-29, 12-30, 13-14, 13-15, 13-16, 13-17, 13-18, 13-131, 13-20, 13-21, 13-22, 13-23, 13-24, 13-25, 13-26, 13-27, 13-28, 13-29, 13-30, 14-15, 14-16, 14-17, 14-18, 14-141, 14-20, 14-21, 14-22, 14-23, 14-24, 14-25, 14-26, 14-27, 14-28, 14-29, 14-30, 15-16, 15-17, 15-18, 15-151, 15-20, 15-21, 15-22, 15-23, 15-24, 15-25, 15-26, 15-27, 15-28, 15-29, 15-30, 16-17, 16-18, 16-161, 16-20, 16-21, 16-22, 16-23, 16-24, 16-25, 16-26, 16-27, 16-28, 16-29, 16-30, 17-18, 17-171, 17-20, 17-21, 17-22, 17-23, 17-24, 17-25, 17-26, 17-27, 17-28, 17-29, 17-30, 18-19, 18-20, 18-21, 18-22, 18-23, 18-24, 18-25, 18-26, 18-27, 18-28, 18-29, 18-30, 19-20, 19-21, 19-22, 19-23, 19-24, 19-25, 19-26, 19-27, 19-28, 19-29, 19-30, 20-21, 20-22, 20-23, 20-24, 20-25, 20-26, 20-27, 20-28, 20-29, 20-30, 21-22, 21-23, 21-24, 21-25, 21-26, 21-27, 21-28, 21-29, 21-30, 22-24, 22-26, 23-25, 22-28, 23-27, 24-26, 22-30, 23-29, 24-28, 25-27, 22-32, 23-31, 24-30, 25-29, 26-28, 23-33, 24-32, 25-31, 26-30, 27-29, 24-34, 25-33, 26-32, 27-31, 28-30, 25-35, 26-34, 27-33, 28-32, 29-31, 26-36,27-35, 28-34, 29-33, 30-32, 27-37, 28-36, 29-35, 30-34, 31-33, 28-38, 29-37, 30-36, 31-35, 32-34, 29-39, 30-38, 31-37, 32-36, 33-35, 30-40, 31-39, 32-38, 33-37, 34-36, 31-41, 32-40, 33-39, 34-38, 35-37, 32-42, 33-41, 34-40, 35-39, 36-38, 33-43, 34-42, 35-41, 36-40, 37-39, 34-44, 35-43, 36-42, 37-41, 38-40, 35-45, 36-44, 37-43, 38-42 or 39-41 percent by weight.

In some examples, protein may be included at amounts about or at least about 4, 5, 6, 7, 8, 9, 10, 11, 12, 13, 14, 15, 16, 17, 18, 19, 20, 21, 22, 23, 24, 25, 26, 27, 28, 29 or 30 grams per 113 grams of meat analogue formulation or product, or hybrid meat formulation or product.

In some examples, meat hybrids may contain non-dairy protein as above and may also contain protein from real meat. In some examples, real meat may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70 75 or 80 percent by weight of the meat hybrids.

### Fatty Materials and Oils

Generally, the term used herein to refer to lipids is “fats.” In the strict sense, fats are solid at room temperature (e.g., butter) and oils, also a type of lipid, are liquid at room temperature. Herein, the term “fat” may refer to both fats and oils (i.e., all lipids). Herein, the term “fats” generally refers to non-animal fats, like fats from plants.

The fats used to make the meat analogues can be from a variety of sources. In some examples, the sources are non-animal sources (e.g., oils obtained from plants, algae, fungi such as yeast or filamentous fungi, seaweed, bacteria, Archaea), including genetically engineered bacteria, algae, archaea or fungi. The oils can be hydrogenated (e.g., a hydrogenated vegetable oil) or non-hydrogenated. Non-limiting examples of plant oils include almond oil, babassu oil, canola oil, cocoa butter, coconut cream, coconut oil, corn oil, cottonseed oil, flax seed oil, mango butter, margarine, olive oil, orrice bran oil, palm oil, palm kernel oil, peanut oil, sesame oil, rapeseed oil, safflower oil, shea butter, soy oil, sunflower oil, walnut oil, wheatgerm oil, combinations thereof, and others.

In some examples, the amount of fats in the meat analogues or hybrid meats may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 percent by weight.

In some examples, fats may be included in the meat analogue formulations, meat analogue products, hybrid meat formulations or hybrid meat products at amounts that are no more than about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 percent by weight.

In some examples, the amount of fats in the meat analogue formulations, meat analogue products, hybrid meat formulations or hybrid meat products may be between about 2-50, 2-40, 2-35, 2-30, 3-40, 3-35, 3-30, 3-25, 3-20, 4-45, 4-40, 4-35, 4-30, 8-40, 8-38, 8-36, 8-34, 8-32, 9-40, 9-38, 9-36, 9-34, 9-32, 9-30, 10-40, 11-38, 12-36, 13-34, 14-32, 14-30, 14-28, 14-26, 16-35, 16-24, 16-22, 18-32, 18-24, 18-22, 19-32, 19-30, 19-28, 19-26, 19-24, 19-22, 19-20, 20-32, 20-30, 20-28, 20-26, 20-24, 20-22, 21-32, 21-30, 21-28, 21-26, 21-24, 21-22, 21-20, 21-18, 22-32, 22-30, 22-28, 22-26, 22-24, 22-22, 22-20, 22-18, 23-30, 23-28, 23-26, 23-24, 24-30, 24-28, 24-26, 25-30, 25-28, 25-26 26-32, 26-30, 26-28 or 27-31 percent by weight.

In some examples, fat may be included in the meat analogues or meat hybrids at amounts about 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 grams per 113 grams of meat analogue formulation or meat hybrid.

In some examples, at least some of the fat in the disclosed meat analogues or meat hybrids may be from eggs. In some examples, the meat analogues or meat hybrids disclosed herein may not contain eggs. In some examples, the meat analogues or meat hybrids disclosed herein may specifically exclude egg protein.

In some examples, the meat analogues or meat hybrids may contain no lipids or fats.

### Emulsifiers

Herein, emulsions are colloidal solutions with both the dispersed phase and the dispersion medium being liquid. Emulsions can be formed from two liquids that are not miscible. In some examples, an emulsion is an oil (dispersed phase) in water (dispersion medium) emulsion. In unstable emulsions, the liquids will separate in absence of agitation.

Herein, emulsifiers are substances that stabilize emulsions. Generally, emulsifiers used in the disclosed non-dairy cheese analog formulations and products may be emulsifiers commonly used for oil in water emulsions in food products. In some examples, the emulsifiers used may be lecithins. Lecithins may be from a variety of sources. Generally, the lecithins used herein are from non-animal sources. The lecithins used herein may be from plant sources. In some examples, the lecithins used herein are de-oiled lecithins. Example plant-based lecithins may be from canola, coconut, corn, cottonseed, rapeseed, soy, sunflower and other plants.

In some examples, one or more emulsifiers, including lecithins, may be included in the meat analogues or meat hybrids. Generally, the emulsifiers are used in amounts that stabilize an emulsion. In some examples, emulsifiers may be present in the formulations/products at about 0.01, 0.02, 0.03, 0.04, 0.05, 0.06, 0.07, 0.08, 0.09, 0.1, 0.12, 0.14, 0.16. 0.18, 0.2, 0.22, 0.24, 0.26, 0.28, 0.3, 0.32, 0.34, 0.36, 0.38. 0.4, 0.42, 0.44, 0.46, 0.48, 0.5, 0.52, 0.54, 0.56, 0.58, 0.6, 0.62, 0.64, 0.66, 0.68, 0.7, 0.8, 0.82, 0.84, 0.86, 0.88, 0.9, 0.92, 0.94, 0.96, 0.98, 1.0, 1.1, 1.2, 1.3, 1.4, 1.5, 1.6, 1.7, 1.8, 1.9 or 2.0 weight percent.

In some examples, the meat analogues or meat hybrids may contain no emulsifiers, may contain no emulsifiers in addition to other ingredients that may have emulsification activity, or may contain no lecithin emulsifiers.

### Sweetening Agents

Sweetening agents may be used in the meat analogues and meat hybrids disclosed herein. In some examples, the sweetening agents may be carbohydrates, sugars for example. In some examples, the sweetening agents may not be carbohydrates. Example sweetening agents for use in baked goods are known in the art. Some exemplary sweetening agents may include glycerin, erythritol, stevia, monk fruit, and others. Individual sweetening agents may be used individually or in combination.

In some examples, sweetening agents may be present in the meat analogues or meat hybrids at levels that are about or less than about 1, 1.5, 2.0, 2.5, 3.0, 3.5, 4.0, 4.5, 5.0, 5.5, 6.0, 6.5, 7.0, 7.5, 8.0, 9.5 or 10 percent by weight.

In some examples, sweetening agents may be present at about 0.1, 0.2, 0.3, 0.4, 0.5, 0.6, 0.7, 0.8, 0.9, 1.0, 1.2, 1.4, 1.6, 1.8, 200, 2.5, 3.0, 4.0 or 5.0 grams per 113 grams of the meat analogue or meat hybrid.

In some examples, the meat analogue or meat hybrids disclosed herein may contain no sweetening agents.

### Salt

In some examples, one or more salts are used. In some examples, the salt may be sea salt. In some examples, the salt may be added to the meat analogues or meat hybrids at amounts about 0.0001, 0.0002, 0.0003, 0.0004, 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04 or 0.05 weight percent. In some examples, salt may be included at up to 1 or 2 percent by weight.

In some examples, salt may be present in the meat analogues or meat hybrids at about or no more than about 50, 100, 150, 200, 250, 300, 350, 400, 450, 500, 550, 600, 650, 700, 750, 800, 850, 900, 950, 1000, 1050, 1100, 1150, 1200 or more mg per 113 g of the meat analogue or meat hybrid.

In some examples, the salt may be sodium salt. In some examples, the salt may be calcium or other cationic salts.

In some examples, the salt may have emulsifier activity.

In some examples, the meat analogues or meat hybrids may contain no salt.

### Thickening Agents

Generally, thickening agents refer to substances that increase the viscosity of a liquid. Generally, thickening agents increase viscosity without substantially changing other properties of the liquid. Thickening agents may have binder activity. In some examples, separate binders may be used. The thickening agents referred to in this application are generally edible thickening agents. In some examples, the thickening agents used herein may dissolve in a liquid as a colloid that forms a cohesive internal structure (e.g., a gel).

Herein, other components of the formulations and/or compositions disclosed herein (e.g., starch, protein) may functionally act to thicken and or bind together the meat analogues or meat hybrids described herein. Generally, the substances described in this section are added to the formulations to provide additional thickening.

Many different types of thickening agents may be used. Generally, any thickening agent that is acceptable for use in a food product can be used. Usable thickening agents may include polysaccharides, like starches, vegetable gums, pectin and others. Combinations of thickening agents may be used.

In some examples, the thickening/binding agents may be fecula, including almond flour, arrowroot, cornstarch, katakuri starch, potato starch, sago, tapioca, wheat flour and their starch derivatives. Microbial and vegetable gums used as food thickeners may include alginin, guar gum, locust bean gum, xanthan gum and the like. Proteins used as food thickeners may include certain non-dairy proteins. Sugar polymers include may include agar, carrageenan, carboxymethyl cellulose, methylcellulose, pectin and the like.

In some examples, the thickening agent may include a “high acyl gellan gum.” High acyl gellan gum, as used herein, is a polymer comprising various monosaccharides linked together to form a linear primary structure and the gum gels at temperatures of greater than 60° C. The properties of the high acyl gellan gum polymer may vary depending at least in part on its source, how it was processed, and/or the number and type of acyl groups present on the polymer.

Gellan gum is a gel-forming polysaccharide produced by the microbe Sphingomonas elodea. There are several sources of suitable high acyl gellan gums, for example, Ticagel Gellan HS, TIC gums, KELCOGEL High Acyl Gellan Gum, CP Kelco, Gellan Gum LTI00 and Modernist Pantry. Gellan polymers typically consist of monosaccharides beta-d-glucose, beta-d-glucuronic acid and alpha-1-rhamnose in approximate molar ratios of 2:1:1 linked together to form a linear primary structure.

In some examples, a thickening agent may include xanthan gum.

In some examples, the thickening agent(s) and or binders may be included in the disclosed meat analogues or meat hybrids at amounts that are about, at least about, or no greater than about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, 3.0, 3.5, 4.0, 4.5, 10, 15, 20, 25, 30, 35, 40, 45 or 50 percent on a weight basis.

In some examples, the thickening agent(s) may be included in the disclosed meat analogues at amounts that are or are between about 0.1-1, 0.1-0.9, 0.1-0.8, 0.1-0.7, 0.1-0.6, 0.1-0.5, 0.1-0.4, 0.1-0.3, 0.1-0.2, 0.2-1, 0.2-0.9, 0.2-0.8, 0.2-0.7, 0.2-0.6, 0.2-0.5, 0.2-0.4, 0.2-0.3, 0.3-1, 0.3-0.9, 0.3-0.8, 0.3-0.7, 0.3-0.6, 0.3-0.5, 0.3-0.4, 0.4-1, 0.4-0.9, 0.4-0.8, 0.4-0.7, 0.4-0.6, 0.4-0.5, 0.5-1, 0.5-0.9, 0.5-0.8, 0.5-0.7, 0.5-0.6, 0.6-1, 0.6-0.9, 0.6-0.8, 0.6-0.7, 0.6-0.6, 0.7-1, 0.7-0.9, 0.7-0.8, 0.8-1, 0.8-0.9 or 0.9-1.0 weight percent.

In some examples, the meat analogues and meat hybrids may contain no thickening agents or binders.

### Flavoring Agents

Flavors may be used in the meat analogues and meat hybrids disclosed herein. Generally, the flavoring agents provide tastes that help the meat analogues and meat hybrids more closely mimic the taste of various real meats. In some instances, flavor maskers, which mask or hide the taste of the non-dairy proteins, for example, may be used.

A variety of flavors may be used in the meat analogues and meat hybrids. For example, beef, chicken, lamb, mutton, pork, turkey, venison and other flavors may be used. In some examples, various fish/shellfish flavorings may be used.

Various natural flavors, or spices may be used.

In some examples, the disclosed meat analogues and meat hybrids may contain no flavoring agents.

### Coloring Agents

Various agents that provide coloring, generally so the meat analogues and meat hybrids appear as real meats, may be used. In some examples, a caramel powder may be used to provide a beef-like appearance to the meat analogues and meat hybrids.

### Other Ingredients

The meat analogues and meat hybrids disclosed herein may contain added nutrients. Example nutrients may include vitamin A, vitamin B, Vitamin B2, vitamin B6, vitamin B12, vitamin C, vitamin D, vitamin E, vitamin K, biotin, carnitine, taurine, folic acid, pantothenic acid, niacin, choline, calcium, phosphorus, magnesium, zinc, manganese, copper, sodium, potassium, chloride, iron, selenium, chromium, molybdenum, omega-3 fatty acid and the like.

### Methods of Making Meat Analogues

Example processes for making HMEs have already been described herein.

In some example process for making a meat analogue from an HME, the HME may be passed through a cutter device to reduce the sizes of the HME particles. The processed HME may be mixed with other ingredients, including non-HME protein, thickening/binding agents and the like. In some examples, thickening/binding agents may be mixed first. Other ingredients may be added. A high shear mixer may be used to perform the mixing. To form patties, burger or patty forming machines or presses may be used. Other shaped forms of the meat analogues or meat hybrids may be used. In some examples, nuggets may be used.

### Properties of HMEs and Meat Analogues

Generally, the HMEs and meat analogues disclosed herein have a good appearance, aroma, taste and texture of real meat.

In some examples, the HMEs may have certain color values. In some examples, the HMEs may be color neutral. In some examples the HMEs may have L* values of greater than 70, 75, 76, 77, 78, 79, 80, 81, 82, 83, 84, 85, 86, 87 or 88. In some examples, the L* values may be between about 60-90, 65-90, 70-90, 75-90 or 80-90.

In some examples, the HMEs may have a* values between about +6 to −6, +5 to −5, +4 to −4, +3 to −3 or +2 to −2. In some examples, a* for the HMEs may be about 4, about 5 or about 6.

In some examples, the refined protein may have b* values of between about +30 to −30, +28 to −28, +26 to −26, +25 to −25, +23 to −23 or +20 to −20. In some examples, b* for the HMEs may be about 30, 29, 28, 27, 26, 25, 24, 23 or 22. In some examples, B* for the HMEs may be less than about 30, 29, 28, 27, 26, 25, 24, 23 or 22.

In some examples, the HMEs may have a combination of any of the L*, a* and b* values as set forth above.

In some examples, the HMEs may have a certain texture. In some examples, the HMEs may have certain values for Max Force, Toughness and/or Distance to Failure when measured as described in Example 4. In some examples, HMEs may have Max Force values of less than about 6000, 5000, 4000, 3000, 2500 or 2000 g. In some examples, HMEs may have Toughness values of less than about 16,000, 15,000, 14,000, 13,000, 12,000, 11,000, 10,000, 9,000, 8,000, 7,000, 6,000, 5,000, 4,000, 3,000, 2,000 or 1,000 g·sec. In some examples, HMEs may have Distance to Failure values of less than about 25, 20, 15, 10 or 5 mm.

### Embodiments

Some example embodiments of the invention are disclosed in the numbered paragraphs below. Example embodiments are also disclosed in the Claims of this disclosure.

1. A high moisture extrudate (HME), comprising, consisting essentially of or consisting of a salt-precipitated acidic pH or non-salt-precipitated acidic pH non-animal protein preparation.

2. The HME of embodiment 1, wherein the non-animal protein preparation is from a plant source.

3. The HME of one of embodiments 1 or 2, wherein the non-animal protein preparation is from a non-allergenic or hypoallergenic source.

4. The HME of any one of embodiments 1-3, wherein the non-animal protein preparation is from a legume source.

5. The HME of any one of embodiments 1-4, wherein the non-animal protein preparation is from a pea source.

6. The HME of any one of embodiments 1-5, wherein the non-animal protein preparation is from a Pisum sativum source.

7. The HME of any one of embodiments 1-6, wherein the non-animal protein preparation is precipitated at an acidic pH.

8. The HME of any one of embodiments 1-7, wherein the salt-precipitated acidic non-animal protein preparation is precipitated using a calcium salt.

9. The HME of any one of embodiments 1-8, wherein the non-animal protein preparation has an aqueous solubility of less than about 15, 14, 13, 12, 11, 10, 9, 8, 7, 6, 5, 4, 3, 2 or 1% (w/w).

10. The HME of any one of embodiments 1-9, wherein the non-animal protein preparation has a solution pH of less than about 7.1, 7.0, 6.9, 6.8, 6.7, 6.6, 6.5, 6.4, 6.3, 6.2, 6.1, 6.0, 5.9, 5.8. 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1 or 3.0.

11. The HME of any one of embodiments 1-10, wherein the non-animal protein preparation has a sodium content of less than about 4500, 4000, 3500, 3000, 2500, 2000, 1500, 1000, 900 or 800 ppm.

12. The HME of any one of embodiments 1-11, wherein ingredients added to a high moisture extrusion cooking (HMEC) process that results in the HME include between about 40-100, 50-100, 60-100, 70-100, 79-100, 80-100, 90-100, 95-100 or 100 percent by weight of the non-animal protein preparation.

13. The HME of any one of embodiments 1-12, wherein the non-animal protein preparation is the only source of protein in the HME or the only refined protein source in the HME.

14. The HME of any one of embodiments 1-12, wherein the HME includes a second non-animal protein preparation.

15. The HME of embodiment 14, wherein the second non-animal protein preparation is from a plant source different than that of first non-animal protein preparation.

16. The HME of one of embodiments 14 or 15, wherein the second non-animal protein preparation is from a fava bean source.

17. The HME of any one of embodiments 14-16, wherein ingredients added to a high moisture extrusion cooking (HMEC) process that result in the HME include between about between 0-10, 0-15, 0-20, 0-25, 0-30, 0-35, 0-36, 0-45, 0-50, 0-55, 0-60, 1-10, 1-15, 1-20, 1-25, 1-30, 1-35, 1-36, 1-45, 1-50, 1-55 or 1-60 percent by weight of the second non-animal protein preparation.

18. The HME of any one of embodiments 14-17, wherein the first non-animal protein preparation and the second non-animal protein preparation are the only sources of protein or the only sources of refined protein in the HME.

19. The HME of any one of embodiments 1-18, wherein the non-animal protein preparation is prepared by a process comprising, consisting essentially of or consisting of:

a) obtaining a protein preparation from a plant;

b) optionally, washing the protein preparation at a wash pH;

c) extracting the protein preparation at an extraction pH to obtain an aqueous protein solution;

d) separating the aqueous protein solution from non-aqueous components;

e) optionally, adding salt;

f) adjusting the aqueous protein solution to a precipitation pH to precipitate protein and obtain a protein precipitate;

g) separating the protein precipitate from non-precipitated components; and

h) washing the protein precipitate to obtain the non-animal protein preparation.

20. The HME of any one of embodiments 1-19, wherein an amount of protein added to a high moisture extrusion cooking (HMEC) process that results in the HME includes at least 80, 82, 84, 86, 88, 90, 91, 92, 93, 94, 95, 96, 97, 98, 99 or 100 percent by weight of ingredients added to the HMEC process.

21. A high moisture extrudate (HME), comprising, consisting essentially or consisting of 95, 96, 97, 98, 99 or 100 percent by weight of a salt-precipitated acidic pH or non-salt-precipitated acid pH non-animal protein preparation.

22. The HME of embodiment 21, wherein the non-animal protein has a solution pH of less than about 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7 or 6.8.

23. A meat analogue or hybrid meat comprising, consisting essentially of or consisting of the high moisture extrudate (HME) of any one of embodiments 1-22 as an ingredient.

24. The meat analogue or hybrid meat of embodiment 23, comprising an amount of the HME that is at least 10, 15, 20, 25, 30, 35, 40, 45 or 50 percent by weight of the meat analogue or hybrid meat.

25. The meat analogue or hybrid meat of one of embodiments 23 or 24, additionally comprising a non-animal protein preparation that is not part of an HME.

26. The meat analogue or hybrid meat of any one of embodiments 23-25, additionally comprising one or more of a fat, a thickening or binding agent, or a flavoring agent.

27. The meat analogue or hybrid meat of any one of embodiments 23-26, additionally comprising a fish, shrimp, pork, beef or chicken flavoring agent.

28. The meat analogue or hybrid meat of any one of embodiments 23-27, in the form of a ball, bar, cube, nugget, patty or stick.

29. A meat analogue comprising, consisting essentially of or consisting of the high moisture extrudate (HME) of any one of embodiments 1-22 and a non-animal protein preparation that is not part of an HME.

30. The meat analogue of embodiment 29, wherein the HME is at least 30, 35, 40, 45 or 50 percent by weight of the meat analogue.

31. The meat analogue of one of embodiments 29 or 30, wherein the non-animal protein preparation that is not part of an HME is at least 1.5, 2.0. 2.5, 3.0, 3.5, 4.0, 4.5 or 5.0% by weight of the meat analogue.

32. The meat analogue of any one of embodiments 29-31:

wherein the HME is at least 30, 35, 40, 45 or 50 percent by weight of the meat analogue; and

wherein the non-animal protein preparation that is not part of a HME is at least 1.5, 2.0. 2.5, 3.0, 3.5, 4.0, 4.5 or 5.0% by weight of the meat analogue.

33. A hybrid meat comprising, consisting essentially of or consisting of the high moisture extrudate (HME) of any one of embodiments 1-22, and real meat.

34. The hybrid meat of embodiment 33, wherein the real meat includes fish, shrimp, pork, beef or chicken.

35. The hybrid meat of one of embodiments 33 or 34, additionally comprising a non-animal protein preparation that is not part of an HME.

36. A meat analogue comprising, consisting essentially of or consisting of a non-animal, acidic protein preparation as the only source of protein or the only refined protein source in the meat analogue.

37. The meat analogue of embodiment 36, wherein the salt-precipitated non-animal protein has a solution pH of less than about 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7 or 6.8.

38. The meat analogue of one of embodiments 36 or 37, wherein the meat analogue does not contain a high moisture extrudate (HME) as an ingredient.

### EXAMPLES

The following examples are for illustrating various embodiments and are not to be construed as limitations.

### Example 1: Refined Protein Preparations

The refined protein preparations used to prepare the high moisture extrudates (HMEs), as well as the meat analogues disclosed herein may be salt-precipitated plant proteins or non-salt-precipitated plant proteins. Generally, however, these proteins have an acidic pH. In this example, some physical characteristics of these proteins were examined.

In a first study, calcium-precipitated pea protein preparations were compared with two other commercially available refined protein preparations, also from pea plants, that were not salt-precipitated. Herein, the two commercially available refined protein preparations are referred to as Competitor #1 and Competitor #2.All three refined protein preparations (i.e., the salt-precipitated, Competitor #1 and Competitor #2 preparations) were in powder form. The three refined protein preparations were characterized as described below.

First, the particle size distribution (Dx50) for each refined protein preparation was determined and is shown in Table 1. Although not shown, the distribution of particle sizes for each protein preparation was unimodal and roughly symmetrical.

Solubility in water was also determined for each protein preparation and is shown in Table 1. To determine solubility, a 5% protein load was added to 10 ml of water at room temperature and a slurry was made. After 30 minutes, the slurry was centrifuged and the amount of protein in the supernatant was determined using a combustion method. Solubility was calculated.

The pH of water that contained a 10% (w/w) solution of the refined protein preparations was determined and is shown in Table 1. To make this determination, water was supersaturated with the protein preparation at 10% (w/w) and pH of the solution was then determined.

Finally, the amount of sodium, on a ppm basis, was determined for each protein preparation and is shown in Table 1.

TABLE 1
Properties of Refined Proteins

| | | Aqueous | Solution | Sodium |
|---|---|---|---|---|
| Protein | Dx50 | Solubility | pH | Content |
| Preparation 1 | (μm) | (% w/w) | (10% w/w) | (ppm) |
| Salt-precipitated | 50 | 2 | 5.5 | 802 |
| protein | | | | |
| Competitor #1 | 114 | 21 | 7.4 | 7530 |
| Competitor #2 | 36 | 15 | 7.1 | 4640 |

The data showed that the salt-precipitated protein preparation had a particle size (50 μm) smaller than the particle size of Competitor #1 (114 μm) and larger than the size of Competitor #2 (36 μm). The aqueous solubility of the salt-precipitated protein (2%) was less than the aqueous solubility of both Competitor #1 (21%) and Competitor #2 (15%) protein preparations.

The pH of a 10% solution of the salt-precipitated protein (5.5) was less than a 10% solution of both Competitor #1 (7.4) and Competitor #2 (pH 7.1) protein preparations. In other studies (not shown here), the solution pH of independently prepared salt-precipitated protein preparations was similarly determined. The mean±standard deviation of the solution pH of 5 independently prepared salt-precipitated protein preparations was 5.45±0.12.

Also, the sodium content of the salt-precipitated protein (802 ppm) was less than that of both Competitor #1 (7530 ppm) and Competitor #2 (4640 ppm) protein preparations.

In a second study, pea protein preparations prepared in the same way as the salt-precipitated preparation used above, except that the protein precipitation step was performed at acidic pH with no added salt were examined for pH. The solution pH, determined as described above, was determined for 16 independently prepared protein preparations. The mean and variation of these determinations was 5.63±0.11.

In a second study, non-salt-precipitated pea protein preparations were compared with two other commercially available refined protein preparations, also from pea plants, that were also not salt-precipitated. Competitor #1 and Competitor #2 refined proteins preparations were as used for the earlier experiments. The data obtained using these proteins is described below and shown in Tables 2-10.

The compositions of the refined protein preparations were determined using standard AOAC methods (Association of Official Analytical Chemists; www.aoac.org). Moisture content was determined using AOAC 950.46A, using a vacuum oven. Protein content was determined using AOAC 992.23, using a combustion analyzer. Ash content was determined using AOAC 950.14A, using a muffle oven. Fat content was determined using acid hydrolysis according to AOAC 922.06). Carbohydrate content was determined by difference.

Table 2 shows example compositional analyses of the refined protein preparations.

TABLE 2
Compositional Analysis of Refined Proteins

| | | Fat | Protein | Ash | Carbo- |
|---|---|---|---|---|---|
| Protein | Moisture | (% dry | (% dry | (% dry | hydrate |
| Preparation | (%) | basis) | basis) | basis) | (% dry basis) |
| Non-salt- | 3.67 | 10.01 | 84.62 | 4.01 | 1.36 |
| precipitated | | | | | |
| protein | | | | | |
| Competitor #2 | 5.91 | 8.83 | 82.50 | 6.38 | 2.30 |
| Competitor #1 | 5.50 | 9.60 | 85.30 | 4.70 | 0.40 |

In terms of proximate composition, as shown in Table 2, all three proteins appear similar. Differences in performance during extrusion therefore may be due to properties beyond those shown in Table 2.

Color of the refined protein powders was measured using a Datacolor 45S Portable Spectrophotometer. Briefly, samples (˜30 g) were filled into plastic cuvettes. The aperture of the spectrophotometer was pressed against the side of the cuvette and the color was measured. L* represents the Lightness (0 represents black, 100 represents white), a* represents color on a red-green axis (+a represents red, −a represents green), and b* represents color on a yellow-blue axis (+b represents yellow, −b represents blue).

TABLE 3
Color of Refined Proteins

| Protein Preparation | L* | a* | b* |
|---|---|---|---|
| Non-salt-precipitated protein | 80.10 | 3.60 | 25.2 |
| Competitor #2 | 80.36 | 0.82 | 18.52 |
| Competitor #1 | 79.32 | 5.40 | 85.30 |

All three proteins show similar levels of Lightness (L*). Competitor #2 appears less red than non-salt-precipitated protein and Competitor #1. Competitor #1 is more yellow than non-salt-precipitated protein and Competitor #2.

Rapid Visco Analyzer (RVA) testing of the refined protein preparations used an RVA 4500 (PerkenElmer) rapid viscoanalyzer running the method “Extrusion 1. Viscosity was monitored during the thermal cycle outlined in Table 4, below. Samples consisted of 6 g protein (dry basis) with 25 g of water.

TABLE 4
Rapid Viscoanalyzer Method

| Time (hh:mm:ss) | Function Type | Value |
|---|---|---|
| 00:00:00 | Temperature | 25° C. |
| 00:00:00 | Speed | 960 rpm |
| 00:00:10 | Speed | 160 rpm |
| 00:02:00 | Temperature | 25° C. |
| 00:07:00 | Temperature | 95° C. |
| 00:10:00 | Temperature | 95° C. |
| 00:15:00 | Temperature | 25° C. |
| 00:20:00 | End | — |

The final viscosities of the refined protein preparations are shown in Table 5, below.

TABLE 5
Final Viscosity of Processed Refined Proteins

| | Final |
|---|---|
| Protein Preparation | Viscosity (cP) |
| Non-salt-precipitated protein (Natural pH 5.5) | 95.0 |
| Non-salt-precipitated protein (Adjusted pH 7.0) | 1194.0 |
| Competitor #2 (Natural pH 7.18) | 883.0 |
| Competitor #1 (Natural pH 7.34) | 3584.5 |

The data show that the final viscosity of non-salt-precipitated protein is reduced as compared to the Competitor #2 and Competitor #3 refined proteins at each protein's natural pH (i.e., 6 g of protein in 25 ml water without pH adjustment). Though the non-salt-precipitated protein shows a similar viscosity to Competitor #2 at approximately pH 7.0, proteins are generally extruded without extraneous pH adjustment.

The pH of water that contained a 10% (w/w) solution of the refined protein preparations was determined and is shown in Table 6. To make this determination, water was supersaturated with the protein preparation at 10% (w/w) and pH of the solution was then determined.

TABLE 6
pH of Refined Proteins

| Protein Preparation | pH |
|---|---|
| Non-salt-precipitated protein | 5.50 |
| Competitor #2 | 7.18 |
| Competitor #1 | 7.34 |

As for salt-precipitated protein in Table 1, the pH of a 10% solution of the non-salt-precipitated protein (5.5) was less than a 10% solution of both Competitor #1 and Competitor #2 protein preparations.

Mineral contents of the refined protein preparations were determined by inductively coupled plasma mass spectrometry (ICP-MS) according to AOAC 2015.01 Mod <2232>. The data for calcium, iron, magnesium, phosphorus, potassium and sodium are shown in Table 7.

TABLE 7
Mineral Content of Refined Proteins

| | Calcium | Iron | Magnesium | Phosphorus | Potassium | Sodium |
|---|---|---|---|---|---|---|
| Protein Preparation | (ppm) | (ppm) | (ppm) | (ppm) | (ppm) | (ppm) |
| Non-salt- | 2410 | 193 | 1296 | 9524 | 2546 | 1048 |
| precipitated protein | | | | | | |
| Competitor #2 | 2970 | 56.5 | 981 | 8940 | 5510 | 9540 |
| Competitor #1 | 591 | 165 | 737 | 7960 | 3880 | 7530 |

The data show, that compared to the Competitor #1 and #2 proteins, the non-salt-precipitated protein contained more iron, more magnesium, slightly more phosphorus and, as in Table 1 for salt-precipitated protein, less sodium.

To determine solubility, a 10 percent by weight suspension of protein was made in DI water. The slurry was titrated over the pH range of 4-7 using HCl and NaOH. Samples were taken every 1 pH unit and centrifuged at 4,500 RPM for 5 min. The amount of protein in the supernatant (soluble protein) was determined using a combustion method. Solubility was calculated. The data are shown in Table 8.

TABLE 8
Solubility of Refined Proteins

| | % Soluble Protein | | | |
|---|---|---|---|---|
| Protein Preparation | pH 4 | pH 5 | pH 6 | pH 7 |
| Non-salt-precipitated protein | 3 | 2 | 3 | 5 |
| Competitor #2 | 3 | 1 | 2 | 25 |
| Competitor #1 | 7 | 6 | 14 | 21 |

The data show, that at a pH of 6-7 and above, the non-salt-precipitated protein was less soluble in water than the Competitor #1 and #2 proteins.

Water holding capacity of the refined protein preparations was determined by mixing 2 g of each protein with 40 g of DI water in a tube by vortexing. The samples were allowed to sit for 15 min and were then centrifuged at 4,500 RPM for 15 min. The supernatant was removed. The tubes were allowed to drain for 15 min and then were weighed. The mass absorbed by each sample was calculated. The data (Avg.±SD) are shown in Table 9.

TABLE 9
Water Holding Capacity

| Protein Preparation | g Water/g Protein Preparation |
|---|---|
| Non-salt-precipitated protein | 2.13 ± 0.03 |
| Competitor #2 | 2.87 ± 0.07 |
| Competitor #1 | 3.75 ± 0.04 |

The data show that the non-salt-precipitated protein had a lower water holding capacity than both of Competitor #1 and Competitor #2 proteins. Water holding capacity generally exhibits a positive correlation with protein solubility, which is consistent with the observations shown in Table 8, above.

Oil holding capacity of the refined protein preparations was determined by mixing 0.5 g of each protein with 3 g of sunflower oil in a tube by vortexing. The samples were allowed to sit for 1 hour and were then centrifuged at 3,500 RPM for 15 min. Excess oil was decanted. The mass absorbed by each sample was calculated. The data (Avg.±SD) are shown in Table 10.

TABLE 10
Oil Holding Capacity

| Protein Preparation | g Oil/g Protein Preparation |
|---|---|
| Non-salt-precipitated protein | 0.89 ± 0.04 |
| Competitor #2 | 0.76 ± 0.09 |
| Competitor #1 | 1.13 ± 0.15 |

The oil holding capacity is determined based on the interaction of oil and the nonpolar amino acid side chains of proteins. Generally, oil holding is a key functional property in meat analogs to provide acceptable sensory attributes.

### Example 2: Preparation of High Moisture Extrudates (HMEs) Using Refined Protein

A variety of high moisture extrudates (HMEs) were prepared using high moisture extrusion cooking (HMEC). The HMEs were prepared using non-salt-precipitated protein from pea as described in Example 1 (i.e., protein prepared as described herein in the section titled “Processes for Preparing Refined Plant Protein” where protein precipitation was performed at the precipitation pH without adding salt), as well as with one commercially available pea protein preparation that was not salt-precipitated. The other commercially available protein preparation is different from the protein preparations set forth in the earlier tables and is designated as the Competitor #3 preparation.

The ingredients and amounts for the example HMEs described here are shown below in Table 11.

TABLE 11
Ingredients in HMEs made using HMEC

| Ingredient | HME #4 (wt %) | HME #5 (wt %) | HME #6 (wt %) |
|---|---|---|---|
| Identity of | Non-salt- | Competitor | Non-salt- |
| Pea Protein | precipitated | #3 | precipitated |
| Amount of Pea | 90 | 90 | 100 |
| Protein (wt %) | | | |
| Faba Protein | 10 | 10 | 0 |
| concentrate | | | |
| Total | 100 | 100 | 100 |

The ingredients shown in Table 11 were subjected to HMEC using a Clextal EV 32 twin screw extruder. The parameters of the HMEC process for each of the HMEs produced are shown below in Table 12.

TABLE 12
HMEC parameters

| Parameter | HME #4 | HME #5 | HME #6 |
|---|---|---|---|
| Feed rate (kg/hr) | 10.4 | 10.4 | 12.5 |
| Water flow (kg/hr) | 12.1 | 11.6 | 12.1 |
| Total moisture (%) | 56.1 | 56.1 | 51.3 |
| Barrel zone 1 (° C.) | 50 | 50 | 50 |
| Barrel zone 2 (° C.) | 90 | 90 | 90 |
| Barrel zone 3 (° C.) | 135 | 135 | 135 |
| Barrel zone 4 (° C.) | 145 | 145 | 145 |
| Barrel zone 5 (° C.) | 145 | 145 | 145 |
| Barrel zone 6 (° C.) | 145 | 145 | 145 |
| Die temperature (° C.) | 135 | 130 | 136 |
| SME (Watt*h/kg) | 44.4 | 44 | 44.5 |
| Screw speed (rpm) | 396 | 396 | 396 |
| Cooling temperature (° F.) | 180 | 180 | 180 |
| Cutter speed (rpm) | Hand cut | Hand cut | Hand cut |

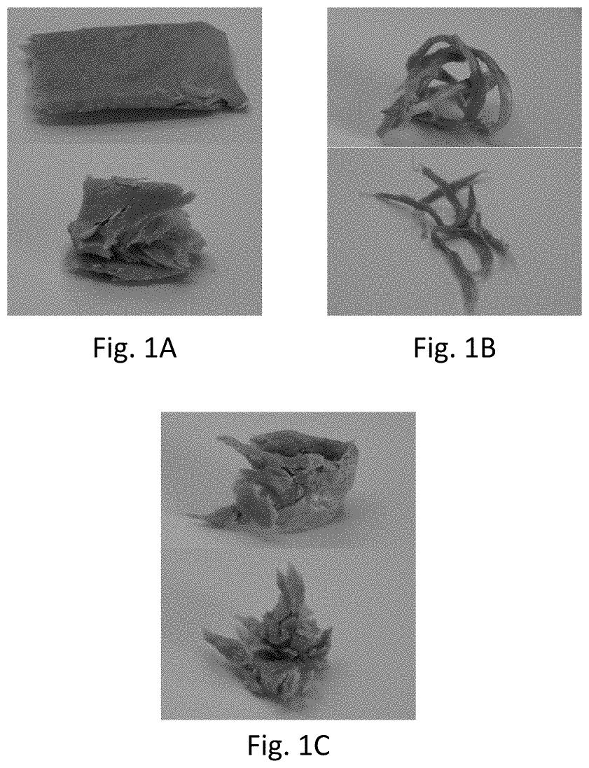

Photographs of some of the HMEs were taken. FIG. 1A shows the extruded HME #4. FIG. 1B shows the extruded HME #5. FIG. 1C shows the extruded HME #6.

Observations on the visual texture and bite of the HMEs shown in FIGS. 1A (HME #4), 1B (HME #5) and 1C (HME #6) are shown below in Table 13.

TABLE 13
Observations made on HMEs

| Property | HME #4 | HME #5 | HME #6 |
|---|---|---|---|
| Visual Texture | Fibrous | Stretchy strings | Fibrous |
| Bite | Chewy | Rubbery | Chewy and |
| | | | firm/dense |

For the HMEs that contained 90 percent by weight of pea protein and 10 percent by weight of faba protein concentrate (HMEs #4 and #5), the HME containing the non-salt-precipitated protein disclosed herein (HME #4) properly formed into ribbons/bars during the extrusion process (FIG. 1A) and had a good visual texture and bite (Table 13). In contrast, the HME containing the Competitor #3, non-salt-precipitated protein (HME #5) formed strings during extrusion (FIG. 1B), which are less desirable than ribbons/bars, had a stretchy string-type of visual texture and had a rubbery bite (Table 13).

For the HME that contained 100% by weight of pea protein (HMEs #6), the HME containing the non-salt-precipitated protein (HME #6) formed a cohesive extrudate during the extrusion process (FIG. 1C). Although a bar/ribbon was not formed (FIG. 1C), the extrusion product had a good visual texture and bite (Table 13).

Some of the above HMEs were used as ingredients to make chicken meat analogues. These studies are described in Example 3, below.

### Example 3: Chicken Analogues

HMEs #4 (90 wt % non-salt-precipitated protein+10 wt % faba protein), #5 (90 wt % Competitor #3 protein+10 wt % faba protein) and #6 (100 wt % non-salt-precipitated protein) were used to make chicken analogues.

Formulations for the various chicken analogues are shown below in Table 14. Chicken analogues made with HMEs containing non-salt-precipitated protein described herein are designated as Sample A and Sample D. Chicken analogues made with the HME containing Competitor #3 pea preparation is designated as Sample C.

For the chicken analogues made using HMEs containing the non-salt-precipitated protein described herein, that has an acidic pH, the chicken analogue designated Sample A contained 45% by weight of HME #4 (see Table 11 in Example 2). HME #4 contained 90 wt % pea protein and 10% faba protein concentrate (input into extruder; final product contains water). The pea protein in HME #4 used in the Sample A chicken analogue was non-salt-precipitated.

The chicken analogue designated Sample D contained 45% by weight of HME #6 (see Table 11 in Example 2). HMMA #6 contained 100 wt % pea protein (input into extruder; final product contains water). The pea protein in HMMA #6 used in the Sample D chicken analogue was non-salt-precipitated.

The chicken analogue designated Sample C contained 45% by weight of HME #5 (see Table 11 in Example 2). HMMA #5 contained 90% pea protein and 10% faba protein concentrate (input into extruder; final product contains water). The pea protein in HMMA #5 used in the Sample C chicken analog was Competitor #3 pea protein that was not salt-precipitated.

All of the chicken analogues (Samples A, C and D) also contained additional non-salt-precipitated pea protein prepared by the process disclosed herein that was not formed into an HME. The additional protein was present at 2 percent by weight in each formulation. Additional ingredients in the chicken analogue formulations were as shown below in Table 14.

TABLE 14
Ingredient Compositions for Chicken Analogues Containing
HMEs Made With Various Proteins

| | Sample A | Sample C | Sample D |
|---|---|---|---|
| | (90 wt % | (90 wt % | (100 wt % |
| | non-salt- | Competitor #3 | non-salt- |
| | precipitated | protein in | precipitated |
| | protein in HME) | HME) | protein in HME) |
| Ingredient | Weight % | Weight % | Weight % |
| HME | 45.0 HME #4 | 45.0 HME #5 | 45.0 HME #6 |
| Additional non-salt- | 2.0 | 2.0 | 2.0 |
| precipitated | | | |
| pea protein | | | |
| Chicken flavoring | 1.0 | 1.0 | 1.0 |
| Salt | 1.0 | 1.0 | 1.0 |
| Sugar | 0.9 | 0.9 | 0.9 |
| Onion powder | 0.75 | 0.75 | 0.75 |
| Garlic granules | 0.75 | 0.75 | 0.75 |
| Black pepper | 0.35 | 0.35 | 0.35 |
| powder | | | |
| Methylcellulose | 1.55 | 1.55 | 1.55 |
| Water (iced) | 37.63 | 37.63 | 37.63 |
| Canola oil | 9.07 | 9.07 | 9.07 |
| Total | 100 | 100 | 100 |

To make the chicken analogues, the HME, chicken flavoring, salt, sugar, onion powder, garlic granules and black pepper powder were combined and mixed (mix #1). Separately, the methylcellulose and non-HME pea protein were combined and mixed (mix #2). Mix #2 was slowly added to the iced water and was blended. The canola oil was then added to the mix #2 in water with mixing to produce a thick and pasty mixture (mix #3). Mix #1 was added to Mix #3 and combined using a mixer. The product was formed into patties of about 100 grams each.

### Example 4: Preparation of High Moisture Extrudates (HMEs) Using Refined Protein

Other high moisture extrudates (HMEs) were prepared using high moisture extrusion cooking (HMEC). The HMEs were prepared using non-salt-precipitated protein from pea as described in Example 1 (i.e., protein prepared as described herein in the section titled “Processes for Preparing Refined Plant Protein” where protein precipitation was performed at the precipitation pH without adding salt), as well as with two commercially available pea protein preparations that were not salt-precipitated (Competitor #1 and #2 preparations).

The ingredients and amounts for the example HMEs described here are shown below in Table 15. Pea fiber was commercially available insoluble fiber (about 48% fiber, 36% starch and 7% protein). Pea starch was commercially available (about 0.4% fiber, 90% starch and 0.3% protein).

TABLE 15
Ingredients in HMEs made using HMEC

| | HME #7 | HME #8 | HME #9 |
|---|---|---|---|
| Ingredient | (wt %) | (wt %) | (wt %) |
| Identity of Pea | Non-salt- | Competitor | Competitor |
| Protein | precipitated | #1 | #2 |
| Amount of Pea | 90 | 90 | 90 |
| Protein (wt %) | | | |
| Pea Fiber | 2 | 2 | 2 |
| Pea Starch | 2 | 2 | 2 |
| Canola Oil | 6 | 6 | 6 |
| Total | 100 | 100 | 100 |

The ingredients shown in Table 15 were subjected to HMEC using a Clextral EV 44+ twin screw extruder. The parameters of the HMEC process for each of the HMEs produced are shown below in Table 16.

TABLE 16
HMEC parameters

| Parameter | HME #7 | HME #8 | HME #9 |
|---|---|---|---|
| Feed rate (kg/hr) | 34.8 | 34.8 | 37.0 |
| Water flow (kg/hr) | 44.0 | 41.0 | 41.0 |
| Total moisture (%) | 57.5 | 56.8 | 59.7 |
| Barrel zone 1 (° C.) | 50 | 50 | 50 |
| Barrel zone 2 (° C.) | 80 | 80 | 80 |
| Barrel zone 3 (° C.) | 120 | 120 | 120 |
| Barrel zone 4 (° C.) | 145 | 138 | 138 |
| Barrel zone 5 (° C.) | 145 | 138 | 138 |
| Barrel zone 6 (° C.) | 145 | 138 | 138 |
| Barrel zone 7 (° C.) | 145 | 138 | 138 |
| Barrel zone 8 (° C.) | 145 | 138 | 138 |
| Barrel zone 9 (° C.) | 145 | 138 | 138 |
| Barrel zone 10 (° C.) | 145 | 138 | 138 |
| Barrel zone 11(° C.) | 145 | 138 | 138 |
| Die temperature (° C.) | 148 | 139 | 139 |
| SME (Watt*h/kg) | 10.8 | 7.5 | 19.6 |
| Screw speed (rpm) | 450 | 450 | 450 |
| Cooling temperature (° F.) | 180 | 180 | 180 |

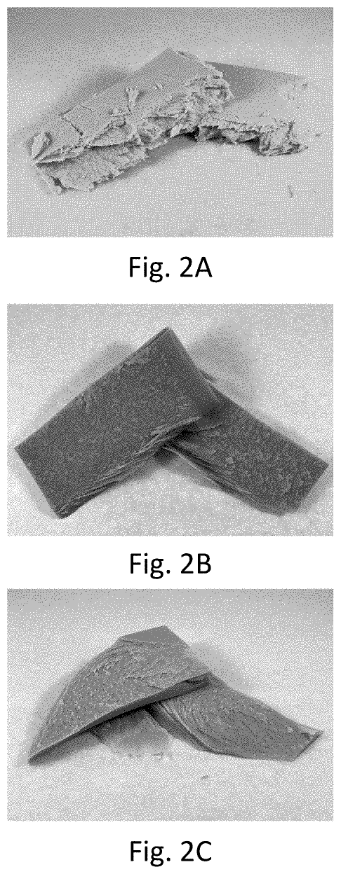

Photographs of these HMEs were taken. FIG. 2A shows the extruded HME #7. FIG. 2B shows the extruded HME #8. FIG. 2C shows the extruded HME #9.

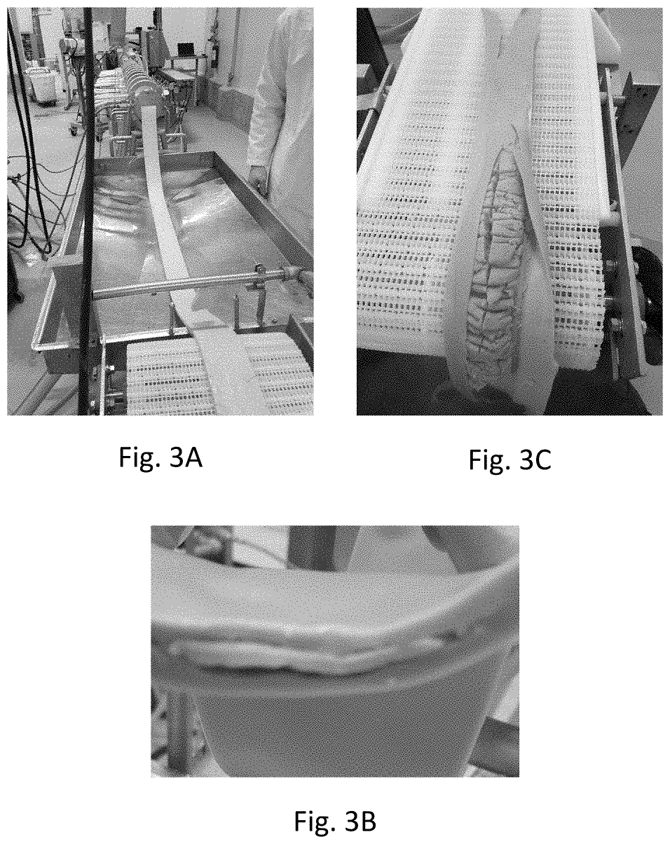

Photographs of these HMEs as they emerged from the extruder after an HMEC are shown in FIG. 3A (HME #7), FIG. 3B (HME #8) and FIG. 3C (HME #9). These photographs bear on processability of HMEs made with the different refined protein preparations. Under the conditions used here, the HME made with non-salt-precipitated protein (HME #7) resulted in consistent, homogenous ribbons without issues. The photographs of HME #8 (FIG. 3B) and HME #9 (FIG. 3C) indicate problems with lamination under these conditions.

Color of HME ribbons was measured using a Datacolor 45S Portable Spectrophotometer. As described in Example 1 for color measurements of refined protein powders, the aperture of the spectrophotometer was pressed directly against the surface of each HME sample and the color was measured. L* represents the Lightness (0 represents black, 100 represents white), a* represents color on a red-green axis (+a represents red, −a represents green), b* represents color on a yellow-blue axis (+b represents yellow, −b represents blue). The data are shown in Table 17. Cooked chicken white meat was used as a control.

TABLE 17
Color of HMEs

| | | |
|---|---|---|
| L* | a* | b* |

| Sample | Avg | SD | Avg | SD | Avg | SD |
|---|---|---|---|---|---|---|
| Chicken | 82.8 | 0.19 | 2.28 | 0.2 | 17.03 | 0.38 |
| HME #7 | 71.33 | 0.66 | 5.93 | 0.11 | 25.45 | 0.48 |
| HME #9 | 62.43 | 0.8 | 7.09 | 0.25 | 32.46 | 0.33 |
| HME #8 | 53.52 | 1.36 | 10.09 | 0.33 | 27.95 | 0.73 |

The data show that the HME made with non-salt-precipitated protein (HME #7) had a lighter color and was more similar to cooked white chicken meat than the HMEs made from the two competitor proteins (HMEs #8 and #9).

Texture of HME ribbons was measured using a TA-XTplus Texture Analyzer with a tug fixture (TA-226) run in tensile mode. The method followed pulled samples at 5 mm/s until a break was detected (75 g break sensitivity) or to 50 mm, whichever condition was met first. The Max Force is the absolute highest value obtained, the Toughness is the area under the curve, and the Distance to Failure is the distance at which the break was detected. The data are shown in Table 18.

TABLE 18
Texture Analysis of HMEs

| | Max Force | | Toughness | | Distance to Failure | |
|---|---|---|---|---|---|---|
| | (g) | | (g · sec) | | (mm) | |
| Sample | Avg | SD | Avg | SD | Avg | SD |
| Chicken | 1187.9 | 393.2 | 3463.6 | 493.7 | 48.1 | 6.5 |
| HME #7 | 1909.5 | 435.9 | 937.8 | 172.0 | 5.6 | 1.2 |
| HME #9 | 8458.6 | 548.8 | 31530.4 | 4843.1 | 33.9 | 4.9 |
| HME #8 | 6739.9 | 250.4 | 16880.1 | 3498.0 | 26.7 | 4.4 |

The data indicate that Max Force and Toughness values for the HME made with non-salt-precipitated protein (HME #7) are closer to values obtained from white meat chicken than are the values obtained from the HMEs made with the competitor proteins (HME #8 and #9). However, Distance to Failure for HME #7 was less similar to the value obtained from white meat chicken than are the values for HMEs #8 and #9. However, this is countered by the increased toughness of HME #8 and #9 as compared to HME #7. Increased toughness creates a generally less acceptable texture. These data indicate that HME #7 has a similar firmness to chicken, but does not have the pull-apart consistency to match.

Observations made on the aroma, taste and texture of the HMEs are shown in Table 19.

TABLE 19
Observations made on HMEs

| Property | HME #7 | HME #8 | HME #9 |
|---|---|---|---|
| Taste and | Clean smell and | Slightly bitter | Very strong sulfur |
| Smell | taste | flavor | aroma |
| Dryness | Somewhat dry | Chalky | Less dry than #7 |
| Fibers | Good fibers | — | Very long, fine |
| | | | fibers |
| Texture | Similar to dry, | Similar to rubber | Very chewy and |
| | white chicken | bands; very tough, | rubbery |
| | meat | will not tear | |

These observations indicate that the HME made with non-salt-precipitated protein has a texture more similar to chicken meat than HMEs made with the competitor proteins. Also, the flavor of the HME made with non-salt-precipitated protein is more neutral than the HMEs made with the competitor proteins.

1. A high moisture extrudate (HME), comprising a salt-precipitated acidic pH or non-salt-precipitated acidic pH non-animal protein preparation.

2. The HME of claim 1, wherein the non-animal protein preparation is from a plant source.

3. The HME of claim 1, wherein the non-animal protein preparation is from a legume source.

4. The HME of claim 1, wherein the non-animal protein preparation is from a pea source.

5. The HME of claim 1, wherein the non-animal protein preparation is precipitated at an acidic pH.

6. The HME of claim 1, wherein the non-animal protein preparation has an aqueous solubility of less than about 10% (w/w) at pH 7.

7. The HME of claim 1, wherein the non-animal protein preparation has a solution pH of less than about 7.0.

8. The HME of claim 1, wherein the non-animal protein preparation, at a pH of less than about 7.0, has a final viscosity after rapid visco analyzer (RVA) testing of less than about 500 cP.

9. The HME of claim 1, wherein the non-animal protein preparation has a water holding capacity of less than about 2.5 g water/g of the protein preparation.

10. The HME of claim 1, wherein ingredients added to a high moisture extrusion cooking (HMEC) process that results in the HME include between about 90-100 percent by weight of the non-animal protein preparation.

11. The HME of claim 1, wherein the HME includes a second non-animal protein preparation.

12. The HME of claim 1, wherein the non-animal protein preparation is prepared by a process comprising:
a) obtaining a protein preparation from a plant;
b) optionally, washing the protein preparation at a wash pH;
c) extracting the protein preparation at an extraction pH to obtain an aqueous protein solution;
d) separating the aqueous protein solution from non-aqueous components;
e) optionally, adding salt;
f) adjusting the aqueous protein solution to a precipitation pH to precipitate protein and obtain a protein precipitate;
g) separating the protein precipitate from non-precipitated components; and
h) washing the protein precipitate to obtain the non-animal protein preparation.

13. The HME of claim 1, wherein the HME has a Max Force of less than about 2000 g or a Toughness of less than about 5,000 g·sec.

14. A meat analogue or hybrid meat comprising the high moisture extrudate (HME) of claim 1 as an ingredient.

15. The meat analogue or hybrid meat of claim 14, comprising an amount of the HME that is at least 40 percent by weight of the meat analogue or hybrid meat.

16. The meat analogue or hybrid meat of claim 14, additionally comprising a non-animal protein preparation that is not part of an HME.

17. A meat analogue comprising the high moisture extrudate (HME) of claim 1 and a non-animal protein preparation that is not part of an HME.

18. The meat analogue of claim 17, wherein the HME is at least 30 percent by weight of the meat analogue.

19. A hybrid meat comprising the high moisture extrudate (HME) of claim 1, and real meat.
